(19) United States
(12) Patent Application Publication
(10) Pub. No.: US 2017/0024142 A1
(43) Pub. Date: Jan. 26, 2017

(54) STORAGE DEVICE

(71) Applicant: Hitachi, Ltd., Tokyo (JP)

(72) Inventors: Yasuo WATANABE, Tokyo (JP); Norio SIMOZONO, Tokyo (JP)

(21) Appl. No.: 15/124,685

(22) PCT Filed: Aug. 29, 2014
(86) PCT No.: PCT/JP2014/072745

§ 371 Date: Sep. 9, 2016

(51) Int. Cl. G06F 3/06

(52) U.S. Cl. CPC G06F 3/0608; G06F 3/0641; G06F 3/0689

(57) ABSTRACT

A storage subsystem according to one preferred embodiment of the present invention comprises multiple storage devices, and a controller for executing an I/O processing to the storage device by receiving an I/O request from a host computer. The controller has an index for managing a representative value of the respective data stored in the storage devices. When a write data is received from the host computer, a representative value of the write data is calculated, and the index is searched to check whether a representative value equal to the representative value of the write data is stored or not. When a representative value equal to the representative value of the write data is stored in the index, the write data and the data corresponding to the same representative value are stored in the same storage device.

### TECHNICAL FIELD

The present invention relates to deduplication of data in a storage subsystem.

### BACKGROUND ART

A deduplication technique is known as a method for efficiently using disk capacities of a storage subsystem. For example, Patent Literature 1 discloses a technique for performing deduplication processing of a flash memory module in a storage system having multiple flash memory modules as storage devices. According to the storage system disclosed in Patent Literature 1, when a hash value of data already stored in a flash memory module corresponds to a hash value of the write target data, the flash memory module having received the write target data from the storage controller further compares the data stored in the relevant flash memory module and the write target data on a bit-by-bit basis. As a result of the comparison, if the data already stored in the flash memory module corresponds to the write target data, the amount of data in the storage media can be cut down by not writing the write target data to the physical block of the flash memory module.

### CITATION LIST

### Patent Literature

### [PTL 1] United States Patent Application Publication No. 2009/0089483

### SUMMARY OF INVENTION

### Technical Problem

In a storage subsystem using multiple storage devices, as disclosed in Patent Literature 1, a logical volume is created using the storage areas of multiple storage devices, and a storage space of the logical volume is provided to a host or other superior device. The correspondence (mapping) between the area in the storage space of the logical volume and the multiple storage devices constituting the logical volume are in a fixed relationship, that is, storage media storing the relevant data is determined uniquely at the point of time when the host instructs the write target data to be written to a given address of the logical volume.

Therefore, according to the deduplication method disclosed in Patent Literature 1, if the data having the same contents as the write target data from the host happens to exist in the write destination storage media, an effect of reducing the storage data quantity by the deduplication process is achieved. However, if the data having the same contents as the write target data from the host exists in a storage media that differs from the write destination storage media, the effect of deduplication cannot be achieved.

### Solution to Problem

The storage subsystem according to one preferred embodiment of the present invention includes multiple storage devices and a controller for controlling the I/O requests from a host computer and I/O processing to the storage device. The controller has an index for managing representative values of respective data stored in the multiple storage devices. When a write data from the host computer is received, the representative value of the write data is calculated, and a search is performed on whether a representative value equal to the representative value of the write data is stored in the index or not. If the representative value equal to the representative value of the write data is stored in the index, the write data and the data corresponding to the equal representative value are stored in the same storage device.

Further, the storage device or the controller has a storage device level deduplication function, and when storing the write data to the storage device, control is performed to store to the storage device only the data that differs from the data stored in the storage device.

### Advantageous Effects of Invention

According to the storage subsystem of a preferred embodiment of the present invention, the efficiency of deduplication can be improved compared to the case where the respective storage devices perform data deduplication independently.

### BRIEF DESCRIPTION OF DRAWINGS

FIG. 1 is a view illustrating an outline of the present embodiment.

FIG. 2 is a view illustrating a concept of stripe data including similar data.

FIG. 3 is a hardware configuration diagram of a computer system.

FIG. 4 is a hardware configuration diagram of a PDEV.

FIG. 5 is a view illustrating a configuration example of logical configuration of a storage.

FIG. 6 is an explanatory view of mapping of the virtual stripe and physical stripe.

FIG. 7 is a view illustrating configuration example of RAID group management information.

FIG. 8 is a view illustrating a configuration example of an index.

FIG. 9 is a view illustrating a configuration example of a coarse-grained address mapping table.

FIG. 10 is a view illustrating a configuration example of a fine-grained address mapping table.

FIG. 11 is a view illustrating a configuration example of a page management table for fine-grained mapping.

FIG. 12 is a view illustrating a configuration example of a PDEV management information.

FIG. 13 is a view illustrating a configuration example of a pool management information.

FIG. 14 is a flowchart of the overall processing when write data is received.

FIG. 15 is a flowchart of a similar data storage process according to Embodiment 1.

FIG. 16 is a flowchart of a storage destination PDEV determination process according to Embodiment 1.

FIG. 17 is a flowchart of a deduplication processing within PDEV.

FIG. 18 is a view illustrating a configuration example of respective management information within PDEV.

FIG. 19 is an explanatory view of a chunk fingerprint table.

FIG. 20 is a flowchart of update processing of deduplication address mapping table.

FIG. 21 is a flowchart of a capacity returning process.

FIG. 22 is a flowchart of a capacity adjustment process of a pool.

FIG. 23 is a flowchart of a storage destination PDEV determination process according to Modified Example 1.

FIG. 24 is a flowchart of a storage destination PDEV determination process according to Modified Example 2.

FIG. 25 is a flowchart of a similar data storage process according to Modified Example 3.

### DESCRIPTION OF EMBODIMENTS

Now, the preferred embodiments of the present invention will be described in detail with reference to the drawings. In all the drawings illustrating the present embodiments, the same elements are denoted with the same reference numbers in principle, and they will not be repeatedly described. When a program or a function is described as the subject in the description, actually, the process is performed by the processor or a circuit executing the program.

At first, a computer system according to Embodiment 1 of the present invention will be described.

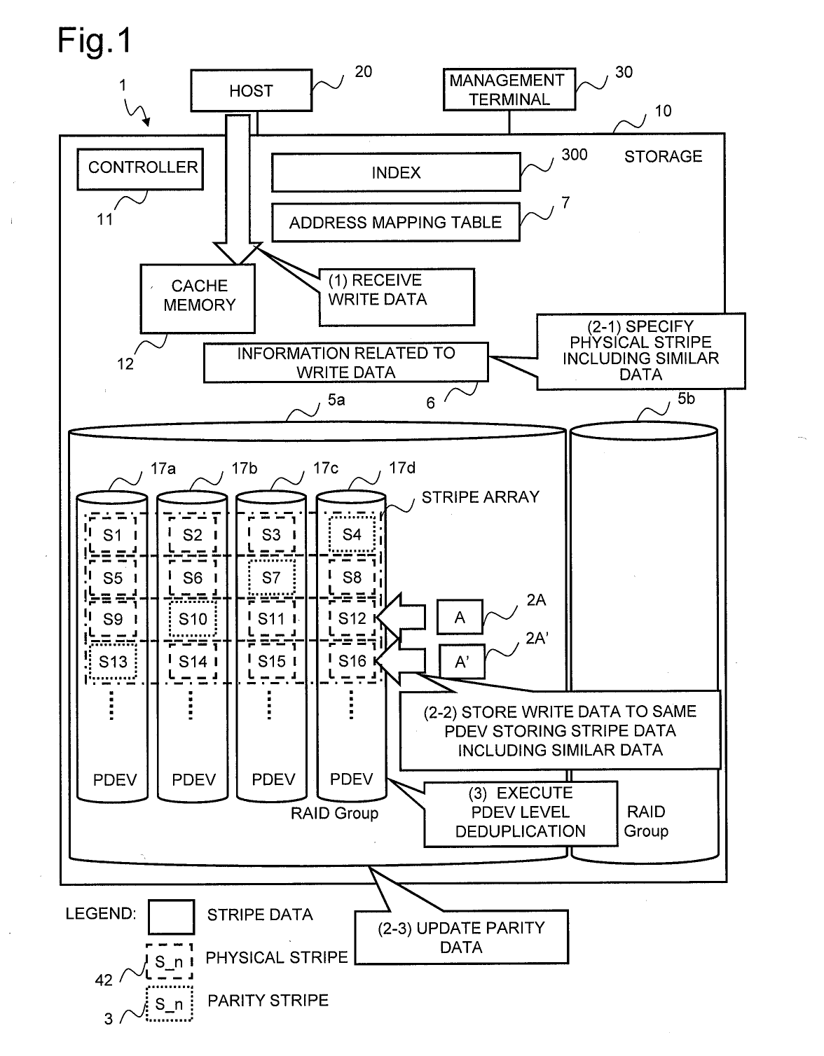

FIG. 1 is a view illustrating an outline of the present embodiment. In the present embodiment, write data is sorted (moved) to a certain physical device (PDEV 17) and deduplication is performed independently in the individual PDEVs 17. The deduplication performed in the independent PDEVs 17 is called a PDEV-level deduplication. In PDEV-level deduplication, the range in which duplicated data is searched is limited within the respective PDEVs 17. In the present embodiment, the PDEV is a device capable of executing PDEV-level deduplication autonomously, but it is also possible to adopt a configuration where the controller of the storage subsystem executes PDEV-level deduplication.

At first, we will describe a data storage area of a storage subsystem 10 (hereinafter abbreviated as “storage 10”).

The storage 10 includes RAID groups (5a, 5b) composed of multiple physical devices (PDEVs 17) using a RAID (Redundant Arrays of Inexpensive (Independent) disks) technique. FIG. 1 illustrates an example where RAID5 is adopted as the RAID level of RAID group 5a. The storage area of PDEV 17 is divided into partial storage areas called stripes, and managed thereby. The size of a stripe is, for example, 512 KB. There are two kinds of stripes, a physical stripe 42, and a parity stripe 3. The physical stripe 42 is a stripe for storing user data (data read or written by a host 20; also referred to as stripe data). The parity stripe 3 is a stripe for storing redundant data (also referred to as parity data) generated from the user data stored in one or more physical stripes 42.

A set of the group of stripes for generating one redundant data and a parity stripe for storing the relevant redundant data is referred to as a stripe array. For example, the physical stripes “S1”, “S2”, “S3” and the parity stripe “S4” in the drawing constitute a single stripe array. The redundant data in the parity stripe “S4” is generated from the stripe data in the physical stripes “S1”, “S2” and “S3”.

Next, we will describe an address space and address mapping in the storage 10.

The address space of a virtual volume (virtual volume 50 described later; also referred to as VVOL) which is a volume that the storage 10 provides to a host computer 20 is referred to as a virtual address space. The address within the virtual address space is referred to as VBA (virtual block address). The address space provided by one or multiple RAID groups is referred to as a physical address space. The address of the physical address space is referred to as a PBA (physical block address). An address mapping table 7 retains the mapping information (address mapping) between the VBA and the PBA. The unit of the address mapping table 7 can be, for example, stripes, or a unit greater than stripes (such as virtual pages 51 or physical pages 41 described later), and not chunks (as described later, a chunk is a partial data obtained by dividing the stripe data). The storage area corresponding to the partial space of the virtual address space is called a virtual volume, and the storage area corresponding to the partial space of the physical address space is called a physical volume.

A mapping relationship of N-to-1 where multiple VBAs are mapped to a single PBA will not occur, and the mapping relationship of VBA and PBA is always a one-to-one mapping relationship. In other words, the operation of migrating the stripe data between physical stripes 42 and changing the address mapping between VBA and PBA itself does not exert an effect of reducing the data quantity as that realized via a general deduplication technique. The operation of (2-2) in FIG. 1 described later relates to a process of migrating the stripe data between physical stripes 42 and changing the mapping between VBA and PBA, wherein the present process does not realize an effect of reducing data quantity by itself, but exerts an effect of enhancing the effect of reducing data quantity by the PDEV-level deduplication of (3) shown in FIG. 1.

Further, the address mapping table 7 can be configured to include a coarse-grained address mapping table 500 and a fine-grained address mapping table 600 described later, or can be configured to include only the fine-grained address mapping table 600 described later.

Next, the various concepts required to describe the outline of the operation of the storage 10 will be described. In the following description, for sake of simplifying the description, a case is described where the size of the data written from the host computer 20 to the storage 10 is either equal to the stripe size or a multiple of the stripe size.

The write data that the storage 10 receives from the host computer 20 (stripe data) is divided into partial data called chunks. The method for dividing the data can be, for example, a fixed length division or a variable length division, which are well known techniques. The chunk size when the fixed length division is performed is, for example, 4 KB, and the chunk size when the variable length division is performed is, for example, 4 KB in average.

Thereafter, in each chunk, a chunk fingerprint is calculated based on the data of the relevant chunk. A chunk fingerprint is a hash value calculated based on the data of the chunk, and a well-known hash function such as SHA-1 and MD5 are used, for example, to calculate the chunk fingerprint.

An anchor chunk is specified using the chunk fingerprint value. An anchor chunk is a chunk subset. The anchor chunk can also be rephrased as a chunk sampled from multiple chunks. The following determination formula can be used, for example, to determine whether a chunk is an anchor chunk or not.

“chunk fingerprint value” mod N=0 Determination formula:

(mod represents residue; N is a positive integer)

The anchor chunk can be sampled regularly using the present determination formula. The method for sampling the anchor chunk is not limited to the method described above. For example, it is possible to set the initial chunk of the write data (stripe data) received from the host computer 20 as the anchor chunk.

In the following description, the chunk fingerprint of the anchor chunk is called an anchor chunk fingerprint. Further, when an anchor chunk fingerprint “FP” is generated from an anchor chunk A within stripe data S, the anchor chunk A is called an “anchor chunk corresponding to anchor chunk fingerprint “FP””. Further, the stripe data S is called a “stripe data corresponding to anchor chunk fingerprint “FP””. The anchor chunk fingerprint [FP] is called an “anchor chunk fingerprint of stripe data S” or an “anchor chunk fingerprint of anchor chunk A”.

An index 300 is a data structure for searching for an anchor chunk information (anchor chunk information 1 (302) and anchor chunk information 2 (303) described later) by using the value of the anchor chunk fingerprint (anchor chunk fingerprint 301 described later) of the anchor chunk stored in the storage 10. The PDEV 17 storing the anchor chunk and the storage position information in the virtual volume can be included in the anchor chunk information. It is possible to include the anchor chunk fingerprint of all the anchor chunks, or to selectively include the anchor chunk information of a portion of the anchor chunks in the index 300. In the latter case, for example, the storage 10 can be set (a) to select N anchor chunks having greater anchor chunk fingerprints out of the anchor chunks included in the stripe data, or (b) when the number of anchor chunks included in a stripe data is n (wherein n is a positive integer) and the VBA of the anchor chunks included in the relevant stripe data arranged in the ascending order is as follows;

VBA(i)(i=1,2, . . . n),

select a value iⱼ (j=1, 2, . . . , m) that satisfies the following condition:

VBA(iⱼ₊₁)−VBA(iⱼ)≧threshold(j=1,2, . . . m)

(wherein m is a positive integer, iⱼ is appositive integer, and i₁<i₂< . . . <iₘ, n>m),

select m number of VBA (iⱼ)=1, 2, . . . m) from the VBAs of the anchor chunks included in the stripe data, and select only the anchor chunk fingerprint corresponding to the selected VBA (iⱼ). By using the selection method of the anchor chunk fingerprint as described in (b), it becomes possible to select a “sparse” anchor chunk within the virtual address space, and the anchor chunk can be selected efficiently.

Next, we will describe the outline of operation of the storage 10.

In FIG. 1 (1), a controller 11 receives a write data from the host computer 20 (hereinafter, the received write data is referred to as relevant write data). The relevant write data is divided into chunks, and information 6 related to write data including a chunk fingerprint and an anchor chunk fingerprint is generated.

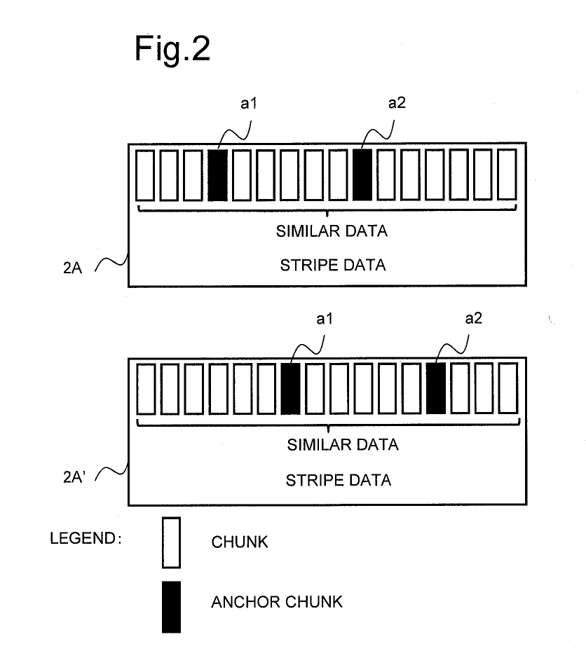

Next, prior to describing the process of (2-1) of FIG. 1, the concept of a stripe data including similar data will be described with reference to FIG. 2.

Stripe data 2 illustrated in FIG. 2 is composed of multiple chunks. A portion of the chunk is the anchor chunk. In the example of FIG. 2, stripe data 2A includes anchor chunks “a1” and “a2”, and stripe data 2A′ similarly includes anchor chunks “a1” and “a2”. It is assumed here that the anchor chunk fingerprints of anchor chunks “a1” included in the stripe data 2A and 2A′ are the same, and that the anchor chunk fingerprints of anchor chunks “a2” included in the stripe data 2A and 2A′ are the same.

Based on the assumption that multiple stripe data including anchor chunks that generate the same anchor chunk fingerprint value is likely to include chunks having the same value, it is possible to assume that the stripe data 2A and stripe data 2A′ are stripe data having a high possibility of including chunks having the same value. In the present embodiment, when the anchor chunk fingerprint of stripe data A and the anchor chunk fingerprint of stripe data B are the same values, stripe data B is referred to as a stripe data including a similar data of stripe data A (it is also possible to state that stripe data A is referred to as a stripe data including a similar data of stripe data B). That is, since the estimation of whether a stripe data is similar or not is performed based on the anchor chunk fingerprint, it is possible to call the anchor chunk fingerprint as a representative value of the stripe data.

In FIG. 1 (2-1), the controller 11 specifies a PDEV 17 including the stripe data similar to the relevant write data. Specifically, for example, the storage 10 searches the index 300 using the anchor chunk fingerprint (called relevant anchor chunk fingerprint) of the respective anchor chunks of the one or multiple anchor chunks included in the relevant write data as the key. By the search, the PDEV 17 storing the stripe data corresponding to the relevant anchor chunk fingerprint is specified. If the search result has multiple hits, the controller 11 selects one of the multiple PDEVs 17 storing the stripe data corresponding to the relevant anchor chunk fingerprint found by the search. The one PDEV 17 specified here is referred to as the relevant PDEV.

FIG. 1 (2-1) can be executed in synchronization with the reception of the relevant write data, or can be executed asynchronously as the reception of the relevant write data. In the latter case, for example, it is possible to adopt a configuration where FIG. 1 (2-1) is to be executed at an arbitrary timing after the relevant write data is temporarily written into the PDEV 17.

In FIG. 1 (2-2), the controller 11 stores the relevant write data in the physical stripe 42 within the PDEV determined in (2-1). It is possible to restate that the process of FIG. 1 (2-2) is a process for sorting (moving) the stripe data including similar data.

When storing the data, the controller 11 selects an unused physical stripe within the relevant PDEV (an unused physical stripe refers to a physical stripe 42 which is not set as the mapping destination of the address mapping table 7; it can also be restated as the physical stripe 42 not having a valid user data stored therein) as the storage destination of the relevant write data, and stores the relevant write data in the selected physical stripe 42. The description that the data is “stored in the physical stripe 42” means that the data is “stored in the physical stripe 42, or stored in a cache memory area (cache memory area refers to a partial area of the cache memory 12) corresponding to the physical stripe 42)”.

In FIG. 1 (2-3), accompanying the storing of the relevant write data to the physical stripe 42, the contents of the parity stripe 3 corresponding to the storage destination physical stripe 42 (parity stripe of the same stripe array as the storage destination physical stripe 42 of the relevant write data) are updated.

In FIG. 1 (3), PDEV-level deduplication is executed to the stripe data including similar data. The deduplication processing can be executed within the PDEV 17, or the controller 11 itself can execute the deduplication process. When the subject of operation performing the deduplication process is the PDEV 17 itself, the PDEV 17 is required to retain a deduplication address mapping table 1100 (address mapping table that differs from the address mapping table 7) in the memory of the PDEV 17 or the like. If the subject of operation performing the deduplication process is the controller 11, the storage 10 must retain the deduplication address mapping table 1100 corresponding to each PDEV 17 in the storage 10.

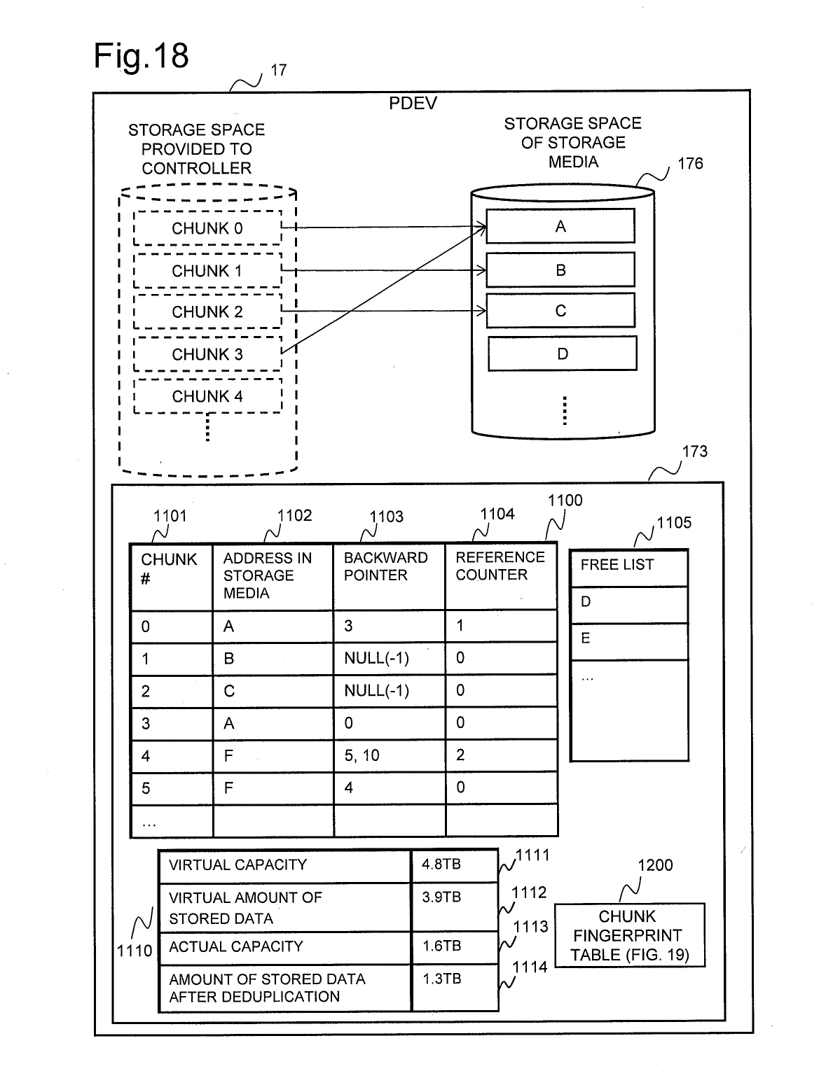

Here, the deduplication address mapping table 1100 is a mapping table for managing the mapping between the address of a virtual storage space that the PDEV 17 provides to the controller 11 (chunk #1101) and the address of a physical storage space of the storage media within the PDEV 17 (address in storage media 1102), which is a mapping table similar to the mapping table used in a well-known general deduplication process. FIG. 18 illustrates this example. FIG. 18 is an example of the deduplication address mapping table 1100 when the PDEV 17 has a deduplication function in chunk units. However, the present invention is not restricted to a configuration where the PDEV 17 has a deduplication function in chunk units.

When identical data is stored in chunk 0 and chunk 3 from the controller 11, the fact that the addresses of the storage media storing the stripe data of chunk 0 and chunk 3 are both A is recorded in the deduplication address mapping table 1100. Thereby, the controller 11 recognizes that data (identical data) is stored in each of chunk 0 and chunk 3 in the (virtual) storage space of the PDEV 17. However, data is actually stored only in address A of the storage media in the PDEV 17. Thereby, when duplicated data is stored in the PDEV 17, the storage area of the storage media can be saved. Information other than the chunk #1101 and the address in the storage media 1102 are managed in the deduplication address mapping table 1100. The details of the various information managed in the deduplication address mapping table 1100 will be described later.

According to the present embodiment, based on the process of FIG. 1 (2-2), the deduplication rate by the PDEV-level deduplication can be improved by having the stripe data including similar data collected in the same PDEV 17, and as a result, the deduplication rate of the whole storage 10 can be improved. Therefore, the costs of the storage subsystem used for the purpose of storing shared files or for the purpose of storing analysis system data can be reduced. In an on-premises environment, companies will be able to construct storage systems at a low cost. In a cloud environment, a cloud vender can provide storage areas at a low cost to the users, and the users can use the cloud service inexpensively.

In the present embodiment, the parity data is updated in FIG. 1 (2-3) after sorting (moving) stripe data in FIG. 1 (2-2), so that the user data and the redundant data can be stored in different PDEVs 17, and the user data can be protected infallibly.

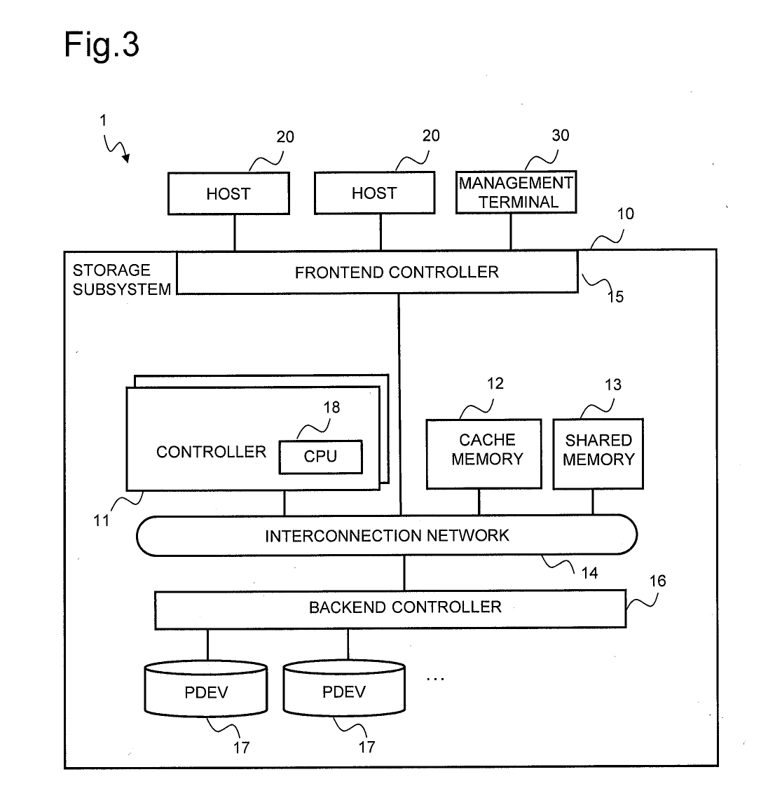

FIG. 3 is a view illustrating a configuration example of a hardware configuration of a computer system 1.

The computer system 1 includes the storage 10, the host computer 20 and a management terminal 30. The host computer 20 and the storage 10 are connected via a SAN (Storage Area Network), for example, and data, process requests and the like are communicated via the network. The management terminal 30 and the storage 10 are connected via a LAN (Local Area Network), for example, and data, process requests and the like are communicated via the network.

At first, we will describe the host computer 20.

The host computer 20 is some type of a computer that the user uses (such as a PC, a server, a mainframe computer and the like). The host computer 20 comprises, for example, a CPU, a memory, a disk (such as an HDD) a user interface, a LAN interface, a communication interface, and an internal bus. The internal bus is for mutually connecting the various components within the host computer 20. Programs such as various driver software and application programs such as a database management system (DBMS) are stored in the disks. These programs are read into the memory, and then read by the CPU for execution. The application program performs read and write accesses to the virtual volume provided by the storage 10.

Next, we will describe the management terminal 30.

The management terminal 30 has a hardware configuration similar to the host computer 20. A management program is stored in the disk of the management terminal 30. The management program is read into the memory, and then read by the CPU for execution. Using the management program, the administrator can refer to various states of the storage 10 and can perform various settings of the storage 10.

Next, we will describe the hardware configuration of the storage 10.

The storage 10 is composed of a controller 11, a cache memory 12, a shared memory 13, an interconnection network 14, a frontend controller 15, a backend controller 16, and a PDEV 17. The controller 11, the frontend controller 15 and the backend controller 16 correspond to the storage control unit.

The cache memory 12 is a storage area for temporarily storing data received from the host computer 20 or a different storage, and temporarily storing data read from the PDEV 17. The cache memory 12 is composed using a volatile memory such as a DRAM or an SRAM, or a nonvolatile memory such as a NAND flash memory, an MRAM, a ReRAM or a PRAM. The cache memory 12 can be built into the controller 11.

The shared memory 13 is a storage area for storing management information related to various data processing in the storage 10. The shared memory 13 can be composed using various volatile memories or nonvolatile memories, similar to the cache memory 12. As for the hardware of the shared memory 13, hardware shared with the cache memory 12 can be used, or hardware that is not shared therewith can be used. Further, the shared memory 13 can be built into the controller 11.

The controller 11 is a component performing various data processing within the storage 10. For example, the controller 11 stores the data received from the host computer 20 to the cache memory 12, writes the data stored in the cache memory 12 to the PDEV 17, reads the data stored in the PDEV 17 to the cache memory 12, and sends the data in the cache memory 12 to the host computer 20. The controller 11 is composed of a local memory, an internal bus, an internal port and a CPU 18 not shown. The local memory of the controller 11 can be composed using various volatile memories or nonvolatile memories, similar to the cache memory 12. The local memory, the CPU 18 and the internal port of the controller 11 are mutually connected via an internal bus of the controller 11. The controller 11 is connected via the internal port of the controller 11 to the interconnection network 14.

The interconnection network 14 is a component for mutually connecting components and for enabling control information and data to be transferred among the mutually connected components. The interconnection network can be composed using switches and buses, for example.

The frontend controller 15 is a component for relaying control information and data being transmitted and received between the host computer 20 and the cache memory 12 or the controller. The frontend controller 15 is composed to include a buffer, a host port, a CPU, an internal bus and an internal port not shown. The buffer is a storage area for temporarily storing the control information and data relayed by the frontend controller 15, which is composed of various volatile memories and nonvolatile memories, similar to the cache memory 12. The internal bus is for mutually connecting various components within the frontend controller 15. The frontend controller 15 is connected to the host computer 20 via a host port, and also connected to the interconnection network 14 via an internal port.

The backend controller 16 is a component for relaying control information and data between the PDEV 17 and the controller 11 or the cache memory 12. The backend controller 16 is composed to include a buffer, a CPU, an internal bus and an internal port not shown. The buffer is a storage area for temporarily storing the control information and data relayed by the backend controller 16, and it can be formed of various volatile memories and nonvolatile memories, similar to the cache memory 12. The internal bus mutually connects various components within the backend controller 16. The backend controller 16 is connected via an internal port to the interconnection network 14 and the PDEV 17.

The PDEV 17 is a storage device for storing data (user data) used by the application program in the host computer 20, the redundant data (parity data), and management information related to various data processes in the storage 10.

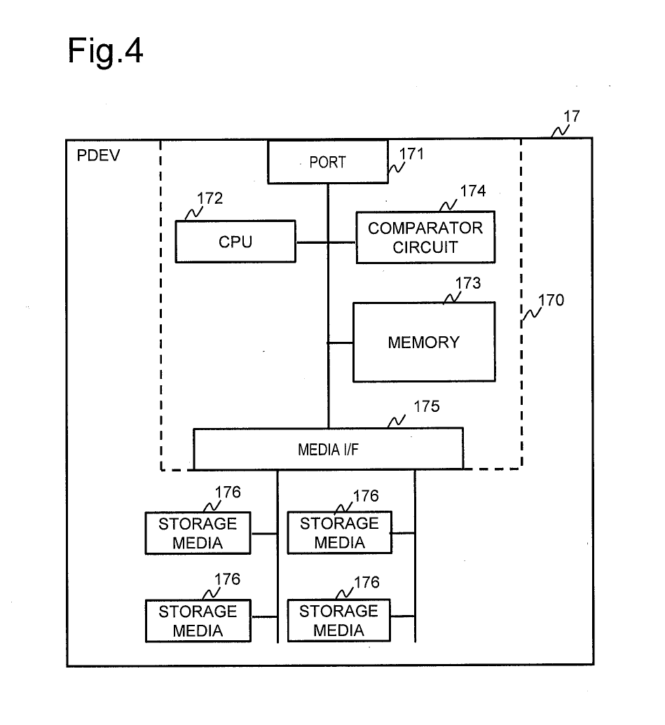

A configuration example of PDEV 17 will be described with reference to FIG. 4. The PDEV 17 is composed to include a controller 170 and multiple storage media 176. The controller 170 includes a port 171, a CPU 172, a memory 173, a comparator circuit 174, and a media interface (denoted as “media I/F” in the drawing) 175.

The port 171 is an interface for connecting to the backend controller 16 of the storage subsystem 10. The CPU 172 is a component for processing I/O requests (such as read requests and write requests) from the controller 11. The CPU 172 processes the I/O requests from the controller 11 by executing programs stored in the memory 173. The memory 173 stores programs used by the CPU 172, the deduplication address mapping table 1100, a PDEV management information 1110 and a free list 1105 described later, and control information, and also temporarily stores the write data from the controller 11 and data read from the storage media 176.

The comparator circuit 174 is a hardware used when performing the deduplication processing described later. The details of the deduplication process are described later, but when the CPU 172 receives a write data from the controller 11, it uses the comparator circuit 174 to determine whether the write data corresponds to the data already stored in the PDEV 17 or not. It is also possible to compare the data by the CPU 172, without providing the comparator circuit 174.

The media interface 175 is an interface for connecting the controller 170 and the storage media 176. The storage media 176 is a nonvolatile semiconductor memory chip, one example of which is a NAND type flash memory. However, a nonvolatile memory such as a MRAM, a ReRAM or a PRAM, or a magnetic disk such as the one used in an HDD, can also be adopted as the storage media 176.

In the above description, a configuration where the PDEV 17 is a storage device capable of performing deduplication (PDEV-level deduplication) autonomously has been described, but as another embodiment, it is possible to provide a configuration where the PDEV 17 itself does not have a deduplication processing function so that the controller 11 performs the deduplication processing. In the above description, a configuration has been described where the PDEV 17 has the comparator circuit 174, but in addition to the comparator circuit 174, the PDEV 17 can also be equipped with a computing unit for calculating the Fingerprint of the data.

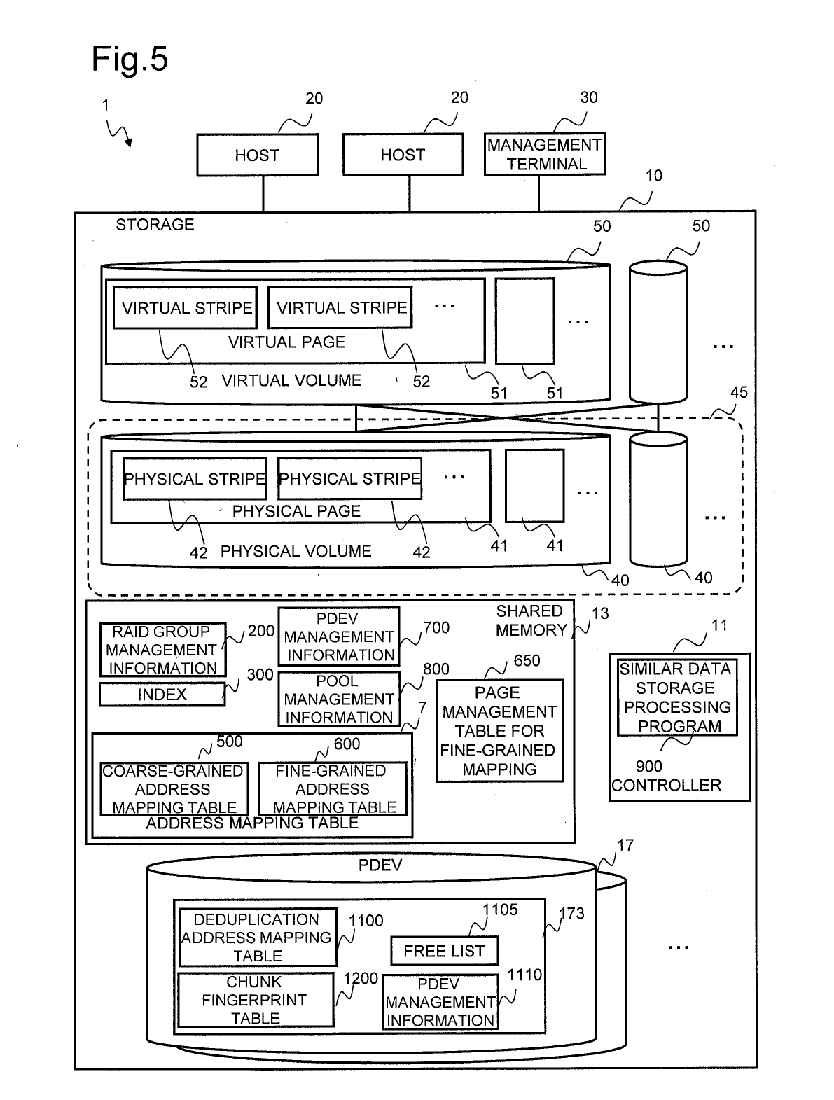

FIG. 5 is a view illustrating a logical configuration example of the storage 10 according to Embodiment 1.

Various tables and various processing programs related to data processing are stored in the storage 10.

Various tables, such as a RAID group management information 200, the index 300, the coarse-grained address mapping table 500, the fine-grained address mapping table 600, a page management table for fine-grained mapping 650, a PDEV management information 700, and a pool management information 800, are stored in the shared memory 13. The various tables can also be configured to be stored in the PDEV 17.

A similar data storage processing program 900 for performing similar data storage processing is stored in a local memory of the controller 11.

Various volumes are defined in the storage 10.

A physical volume 40 is a storage area for storing user data and management information related to various data processing within the storage 10. The storage area of the physical volume 40 is formed based on a RAID technique or a similar technique using the storage area of the PDEV 17. In other words, the physical volume 40 is a storage area based on a RAID group, and the RAID group can be composed of multiple PDEVs 17.

The physical volume 40 is managed by being divided into multiple physical pages 41, which are partial storage areas having a fixed length. The size of a physical page 41 is, for example, 42 MB. The physical page 41 is managed by being divided into multiple physical stripes 42, which are partial storage areas having a fixed length. The size of the physical stripe 42 is, for example, 512 KB. One physical page 41 is defined as an assembly of physical stripes 42 constituting one or multiple stripe arrays.

The controller 11 manages several physical volumes 40 out of the multiple physical volumes 40 defined within the storage 10 as a pool 45. When mapping the physical stripes 42 (or the physical pages 41) to the virtual volume 50 as described later, the controller 11 maps the physical stripes 42 (or the physical pages 41) of the physical volumes 40 managed by the pool 45 to the virtual volume 50.

The virtual volume 50 is a virtual storage area (virtual logical volume) provided to the host computer 20.

The virtual volume 50 is divided into multiple virtual pages 51 which are partial storage areas having a fixed length, and managed thereby. The virtual pages 51 are divided into multiple virtual stripes 52, which are partial storage areas having a fixed length, and managed thereby.

The size of the virtual page 51 and the size of the physical page 41 are the same, and the size of the virtual stripe 52 and the size of the physical stripe 42 are also the same.

The virtual stripes 52 and the physical stripes 42 are mapped via address mapping included in the address mapping table 7.

For example, as shown in FIG. 5, the address mapping table 7 can be composed of two types of address mapping tables, which are the coarse-grained address mapping table 500 and the fine-grained address mapping table 600. The address mapping managed by the coarse-grained address mapping table 500 is called coarse-grained address mapping, and the address mapping managed by the fine-grained address mapping table 600 is called fine-grained address mapping.

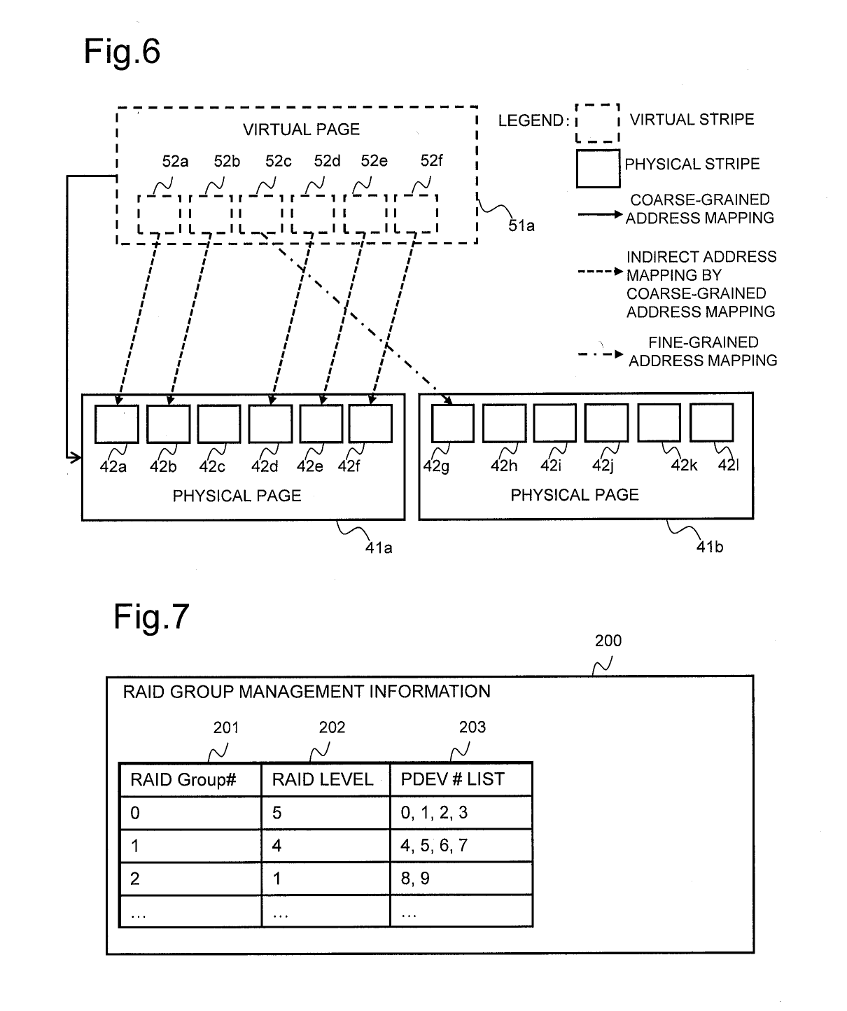

FIG. 6 is a view illustrating an example of mapping of virtual stripes and physical stripes. The present view illustrates an example where the virtual stripes 52 and the physical stripes 42 are mapped via address mapping included in the coarse-grained address mapping table 500 and address mapping included in the fine-grained address mapping table 600.

The coarse-grained address mapping is an address mapping for mapping the physical page 41 to the virtual page 51. The physical page 41 is mapped dynamically to the virtual page 51 in accordance with a thin provisioning technique, which is a well-known technique. Incidentally, a physical page 41 that is not mapped to any virtual page 51 exists, such as a physical page 41b illustrated in FIG. 6.

The coarse-grained address mapping is an address mapping for mapping the physical page 41 to the virtual page 51, wherein the physical stripes 42 included in the relevant physical page 41 is indirectly mapped to the virtual stripes 52 included in the relevant virtual page 51. Specifically, a certain physical page is mapped to a certain virtual page via coarse-grained address mapping, wherein if the number of virtual stripes included in a single virtual page (or the number of physical stripes included in a single physical page) is n, it means that the k-th (1≦k≦n) virtual stripe within the virtual page is implicitly mapped to the k-th physical stripe within the physical page mapped to the relevant virtual page via coarse-grained address mapping. In the example of FIG. 6, since the virtual page 51a is mapped to the physical page 41a via coarse-grained address mapping, the virtual stripes 52a, 52b, 52d, 52e and 52f are respectively indirectly mapped to the physical stripes 42a, 42b, 42d, 42e, 42f. In the drawing of FIG. 6, virtual stripe 52c is not (indirectly) mapped to the physical stripe 42c, the reason of which will be described in detail later.

Fine-grained address mapping is an address mapping for directly mapping the virtual stripes 52 and the physical stripes 42. The fine-grained address mapping is not necessarily set for all the virtual stripes 5. For example, fine-grained address mapping is not set to the virtual stripes 52a, 52b, 52d, 52e and 52f of FIG. 6.

When a valid mapping relationship is set by the fine-grained address mapping 600 between the virtual stripes 52 and the physical stripes 42, the mapping relationship between the virtual stripes 52 and the physical stripes 42 designated by the coarse-grained address mapping 500 is invalidated. For example, in FIG. 6, since a valid address mapping is set between the virtual stripe 52c and the physical strip 42g via fine-grained address mapping, the mapping relationship between the virtual stripe 52c and the physical stripe 42c is substantially invalidated.

It is possible to adopt a configuration where all zero data (data where all bits are zero) is stored in the physical stripe 42, such as the physical stripe 42c, which is not mapped from any virtual stripe 52. By adopting such configuration, when a compression function is applied to the physical page 41, the physical stripe 42 storing all zero data can be compressed to a small size, so that the storage area required to store the physical page 41 in the PDEV 17 can be saved.

The physical stripe 42 to which fine-grained address mapping is applied is the physical stripe 42 set as the storage destination of stripe data including similar data in FIG. 1 (2-2). For example, FIG. 6 illustrates a case where similar data is included in the virtual stripe 52c, and the virtual stripe 52c is mapped via fine-grained address mapping. In the drawing, the virtual stripe 52c is mapped to the physical stripe 42g.

The data where similar data storage processing is not yet executed or the stripe data (unique stripe data) that does not include similar data is stored in the physical stripe 42 mapped via coarse-grained address mapping.

By forming the address mapping table 7 from two types of address mapping tables, which are the coarse-grained address mapping table 500 and the fine-grained address mapping table 600, there will be no need to retain fine-grained address mapping to the virtual stripe 52 that does not contain duplicated data, so the amount of data of the fine-grained address mapping table 600 can be reduced (however, this is limited to the case where the amount of data of the fine-grained address mapping table 600 is increased or decreased depending on the number of the fine-grained address mapping registered in the fine-grained address mapping table 600; one such example is a case where the fine-grained address mapping table 600 is formed as a hash table).

The address mapping table 7 can be composed only via the fine-grained address mapping table 600. In that case, the respective physical stripes 42 are dynamically mapped to the virtual stripes 52 using fine-grained address mapping according to a thin provisioning technique.

As mentioned above, the respective physical stripes 42 are dynamically mapped to the virtual stripes 52. The respective virtual pages 51 are also dynamically mapped to the physical pages 51. Therefore, in the initial state, none of the physical stripes 42 are mapped to the virtual stripes 52, and none of the physical pages 41 are mapped to the virtual pages 51. In the following description, the physical tripe 42 which is not mapped to any of the virtual stripes 52 is referred to as an “unused physical stripe”. Further, the physical page 41 which is not mapped to any of the virtual pages 51 and having all the physical stripes 42 within the physical page 41 being unused physical stripes (physical stripes which are not mapped to virtual stripes 52) is referred to as an “unused physical page”.

Next, the configuration example of the various tables in the storage 10 will be described.

FIG. 7 is a view illustrating a configuration example of the RAID group management information 200. The controller 11 constitutes a RAID group from multiple PDEVs 17. When storing data to the RAID group, redundant data such as a parity is generated, and the data together with the parity are stored in the RAID group.

Information related to the RAID group 5 is stored in the RAID group management information 200. The RAID group management information 200 is referred to as required when accessing the physical volumes 40, so that the mapping relationship between the PBA and the position information within the PDEV 17 are specified.

The RAID group management information 200 is formed to include the columns of a RAID group #201, a RAID level 202 and a PDEV# list 203.

An identifier (identification number) for uniquely identifying the RAID group 5 within the storage 10 is stored in the RAID group #201. In the present specification, “#” is used in the meaning of “number”.

The RAID level of RAID group 5 is stored in the RAID level 202. RAID5, RAID6 and RAID1 are examples of the RAID level capable of being stored thereto.

A list of identifiers of the PDEVs 17 constituting the RAID group 5 is stored in the PDEV # list 203.

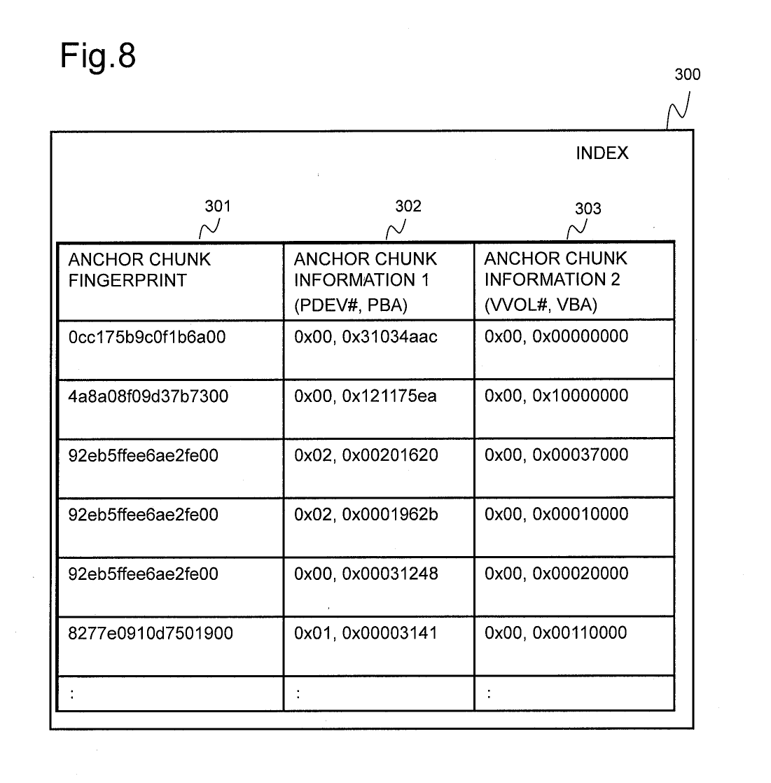

FIG. 8 is a view illustrating a configuration example of the index 300. Information related to the anchor chunk stored in the PDEV 17 is recorded in the index 300.

The index 300 is formed to include the columns of an anchor chunk fingerprint 301, an anchor chunk information 1 (302) and an anchor chunk information 2 (303).

The anchor chunk fingerprint (mentioned earlier) related to the anchor chunk stored in the PDEV 17 is recorded in the anchor chunk fingerprint 301.

Identifiers of PDEVs storing the anchor chunk corresponding to the relevant anchor chunk fingerprint, and the storage position in the PDEV where the anchor chunk is stored (hereinafter, the storage position in the PDEV is referred to as PDEV PBA) are recorded to the anchor chunk information 1 (302). In some cases, the anchor chunk fingerprints generated from chunks stored in multiple storage positions are the same. In that case, multiple rows (entries) having the same values as the anchor chunk fingerprint 301 are stored in the index 300.

An identifier of a virtual volume (VVOL) storing the anchor chunk corresponding to the relevant anchor chunk fingerprint and the storage position (VBA) within the VVOL storing the anchor chunk are recorded in the anchor chunk information 2 (302).

The index 300 can be formed as a hash table, for example. In that case, the key of the hash table is the anchor chunk fingerprint 301, and the values of the hash table are the anchor chunk information 1 (302) and the anchor chunk information 2 (303).

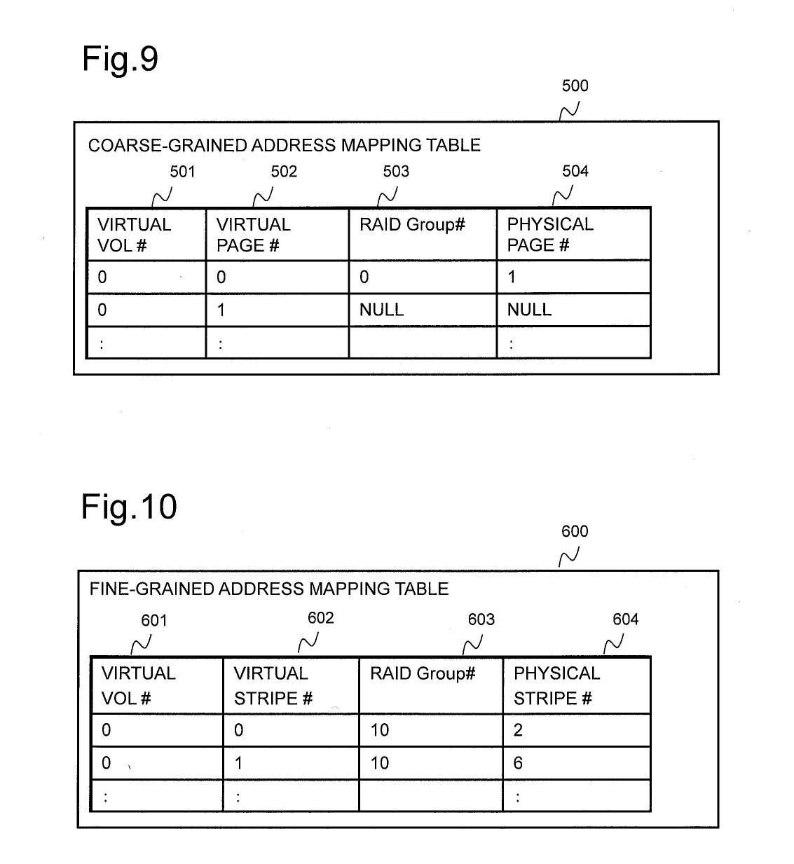

FIG. 9 is a view illustrating a configuration example of the coarse-grained address mapping table 500. Information related to mapping of the virtual pages 51 and the physical pages 41 is recorded in the coarse-grained address mapping table 500.

The coarse-grained address mapping table 500 is formed to include the columns of a virtual VOL #501, a virtual page #502, a RAID group #503 and a physical page #504.

The identifier of a virtual volume and the identifier of a virtual page 51 being the mapping source of address mapping are stored in the virtual VOL #501 and the virtual page #502.

The identifier of a RAID group and the identifier of a physical page 41 being the mapping destination of address mapping are stored in the RAID group #503 and the physical page #504. If address mapping is invalid, an invalid value (NULL; such as −1, which is a value that is not used as the RAID group # or the physical page #) is stored in the RAID group #503 and the physical page #504.

The coarse-grained address mapping table 500 can be formed as an array as shown in FIG. 9, or can be formed as a hash table. When forming the table as a hash table, the keys of the hash table are the virtual VOL #501 and the virtual page #502. The values of the hash table will be the RAID group #503 and the physical page #504.

FIG. 10 is a view illustrating a configuration example of a fine-grained address mapping table 600. Information for mapping the virtual stripes 52 and physical stripes 42 are recorded in the fine-grained address mapping 600.

The fine-grained address mapping table 600 is formed to include the columns of a virtual volume #601, a virtual stripe #602, a RAID group #603 and a physical stripe #604.

An identifier of a virtual volume and an identifier of a virtual stripe 52 being the mapping source of the address mapping are stored in the virtual volume #601 and the virtual stripe #602.

An identifier of a RAID group and an identifier of a physical stripe 42 being the mapping destination of address mapping are stored in the RAID group #603 and the physical stripe #604. If address mapping is invalid, invalid values are stored in the RAID group #603 and the physical stripe #604.

Similar to the coarse-grained address mapping table 500, the fine-grained address mapping table 600 can be formed as an array as shown in FIG. 10, or as a hash table. When the table is formed as a hash table, the keys of the hash table are the virtual volume #601 and the virtual stripe #602. The values of the hash table are the RAID group #603 and the physical stripe #604.

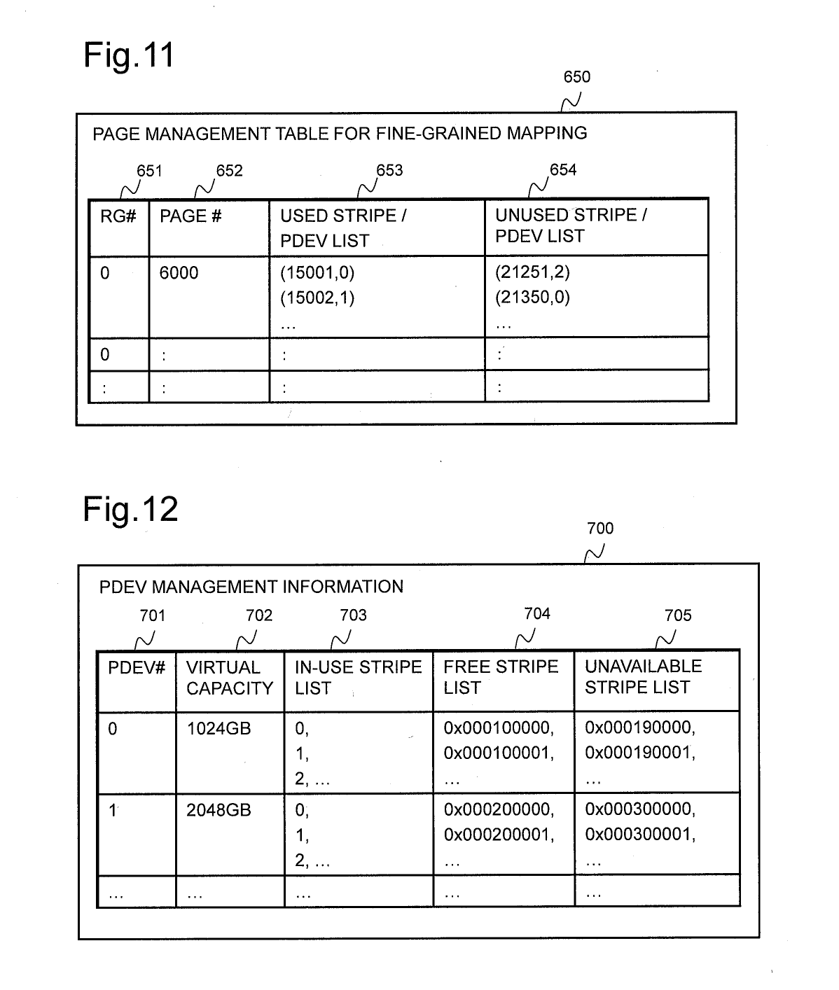

FIG. 11 is a view illustrating a configuration example of the page management table for fine-grained mapping 650. The page management table for fine-grained mapping 650 is a table for managing the physical pages to which the physical stripes mapped via fine-grained address mapping belong. According to the storage 10 of the present embodiment, one or more physical pages are registered in the page management table for fine-grained mapping 650, and when a physical stripe is to be mapped to a virtual stripe via fine-grained address mapping, the physical stripe is selected from the physical pages registered in this page management table for fine-grained mapping 650.

The page management table for fine-grained mapping 650 is formed to include the columns of an RG #651, a page #652, a used stripe/PDEV list 653, and an unused stripe/PDEV list 654. The page #652 and the RG #651 are each a column for storing the physical page # of the physical page registered in the page management table for fine-grained mapping 650, and the RAID group number to which the relevant physical page belongs.

A list of the information of the physical stripes (physical stripe #, and PDEV# of PDEV to which the relevant physical stripe belongs) which belong to the physical page (physical page specified by the RG #651 and the page #652) registered in the page management table for fine-grained mapping 650 are stored in the used stripe/PDEV list 653 and the unused stripe/PDEV list 654. The information of the physical stripes that are being mapped to the virtual stripes via fine-grained address mapping is stored in the used stripe/PDEV list 653. On the other hand, the information of physical stripes not yet mapped to the virtual stripes is stored in the unused stripe/PDEV list 654.

Therefore, when the controller 11 maps the physical stripes to the virtual stripes via fine-grained mapping, one (or more) physical stripe(s) is (are) selected from the physical stripes stored in the unused stripe/PDEV list 654. Then, the information of the selected physical stripe is moved from the unused stripe/PDEV list 654 to the used stripe/PDEV list 653.

FIG. 12 is a view illustrating one example of the contents of the PDEV management information 700. The PDEV management information 700 has the columns of a PDEV #701, a virtual capacity 702, an in-use stripe list 703, a free stripe list 704 and an unavailable stripe list 705. The PDEV #701 is a field storing the identifier of the PDEV 17 (PDEV #). A capacity of the PDEV 17 specified by the PDEV #701 (size of the storage space that the PDEV 17 provides to the controller 11), a list of the physical stripe # of the physical stripes being used, a list of the physical stripe # of the physical stripes in a vacant (unused) state, and a list of the physical stripe # of the physical stripes in an unavailable state are stored in the virtual capacity 702, the in-use stripe list 703, the free stripe list 704 and the unavailable stripe list 705 of the respective rows (entries).

The physical stripes in use refer to physical stripes mapped to the virtual stripes of the virtual volume. The physical stripes in vacant (unused) state (also referred to as free stripes) refer to physical stripes that are not yet mapped to the virtual stripes of the virtual volume, but can be mapped to virtual stripes. Further, the physical stripes in an unavailable state (also referred to as unavailable stripes) refer to physical stripes that are prohibited from being mapped to virtual stripes. When the controller 11 accesses the physical stripes of the PDEV 17, it accesses the physical stripes having physical stripe # stored in the in-use stripe list 703 or the free stripe list 704. However, it does not access the physical stripes having the physical stripe # stored in the unavailable stripe list 705.

At this time, the information stored in the virtual capacity 702 will be described briefly. At the initial state (at the point of time when the PDEV 17 is installed to the storage 10), the controller 11 inquires the information related to the capacity of the PDEV 17 (the capacity of the PDEV 17 or basic information required to derive the capacity of the PDEV 17) to the PDEV 17, and based on the inquired result, the controller 11 stores the capacity of the PDEV 17 in the virtual capacity 702. The details will be described later, but information related to the capacity of the PDEV 17 is returned (notified) when necessary from the PDEV 17 to the controller 11. When the controller 11 receives information from the PDEV 17 related to the capacity of the PDEV 17, it updates the contents stored in the virtual capacity 702 using the received information.

As mentioned earlier, the capacity of the PDEV 17 refers to the size of the storage space that the PDEV 17 provides to the controller 11, but this value is not necessarily the total storage capacity of the storage media 176 installed in the PDEV 17. When deduplication is performed in the PDEV 17, a greater amount of data than the total storage capacity of the storage media 176 installed in the PDEV 17 can be stored in the PDEV 17. Therefore, the capacity of the PDEV 17 is sometimes called “virtual capacity” in the sense that the capacity differs from the actual capacity of the storage media 176.

The PDEV 17 increases (or decreases) the size of the storage space provided to the controller 11 according to the result of the deduplication process. When the size of the storage space provided to the controller 11 increases (or decreases), the PDEV 17 transmits the size (or the information necessary for deriving the size) of the storage space provided to the controller 11 to the controller 11. The details of the method for determining the size will be described later.

Further, even in the initial state (state where no data is written), the PDEV 17 returns a size that is greater than the total storage capacity of the storage media 176 as a capacity (virtual capacity) of the PDEV 17 to the controller 11 with the expectation that the amount of data to be stored in the storage media 176 will be reduced by the deduplication process. However, as another embodiment, in the initial state, the PDEV 17 can be set to return the total storage capacity of the storage media 176 as the capacity (virtual capacity) of the PDEV 17 to the controller 11.

Further, when the deduplication process is executed by the controller 11, the controller 11 determines the value to be stored in the virtual capacity 702 according to the result of the deduplication process.

The virtual capacity may vary dynamically depending on the result of the deduplication process, so that the number of available physical stripes may also vary dynamically. The “available physical stripes” mentioned here are the physical stripes having physical stripe # stored in the in-use stripe list 703 or the free stripe list 704.

When the virtual capacity of the PDEV 17 is reduced, a portion of the physical stripe # stored in the free stripe list 704 is moved to the unavailable stripe list 705. On the other hand, when the virtual capacity of the PDEV 17 is increased, a portion of the physical stripe # stored in the unavailable stripe list 705 is moved to the free stripe list 704.

The movement of physical stripe # performed here will be described briefly. A total amount of storage of the physical stripes being used can be calculated by multiplying the number of physical stripe # stored in the in-use stripe list 703 by the physical stripe size. Similarly, the total amount of storage of the vacant physical stripes can be calculated by multiplying the number of physical stripe # stored in the free stripe list 704 by the size of the physical stripes. The controller 11 adjusts the number of physical stripe # registered in the free stripe list 704 so that the sum of the total amount of storage of the physical stripes being used and the total amount of storage of the vacant physical stripes becomes equal to the virtual capacity 702.

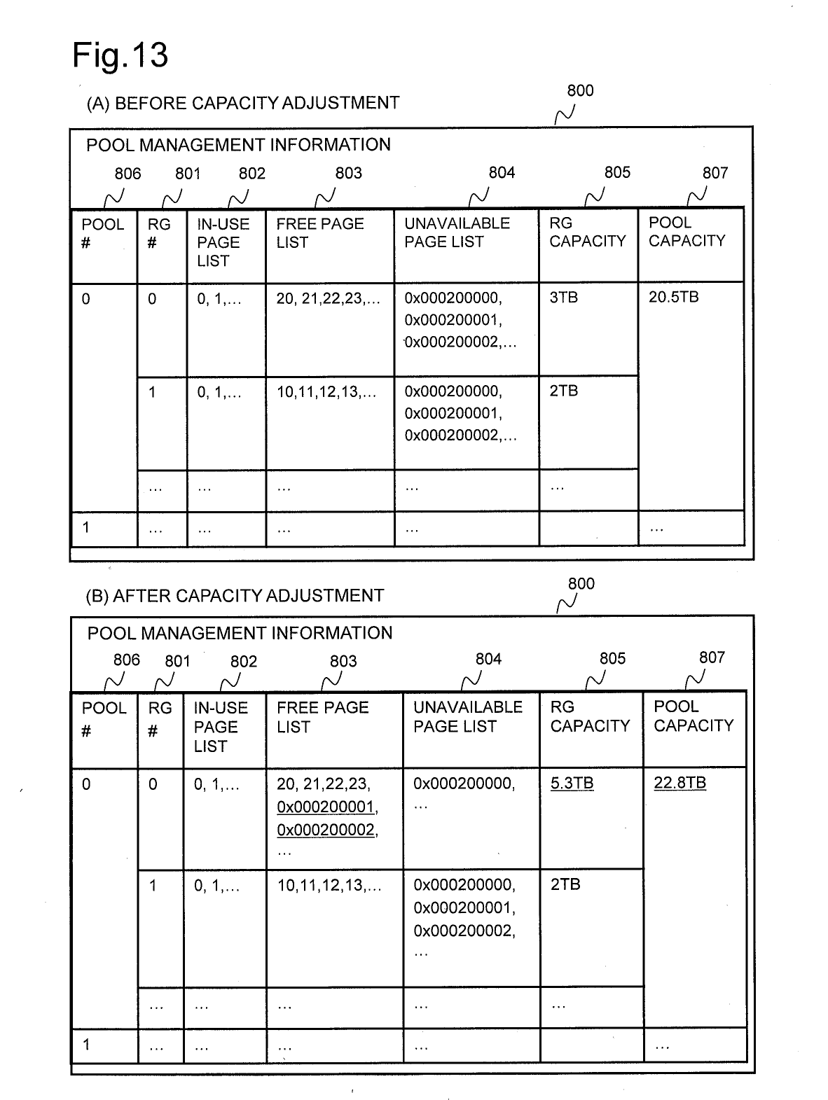

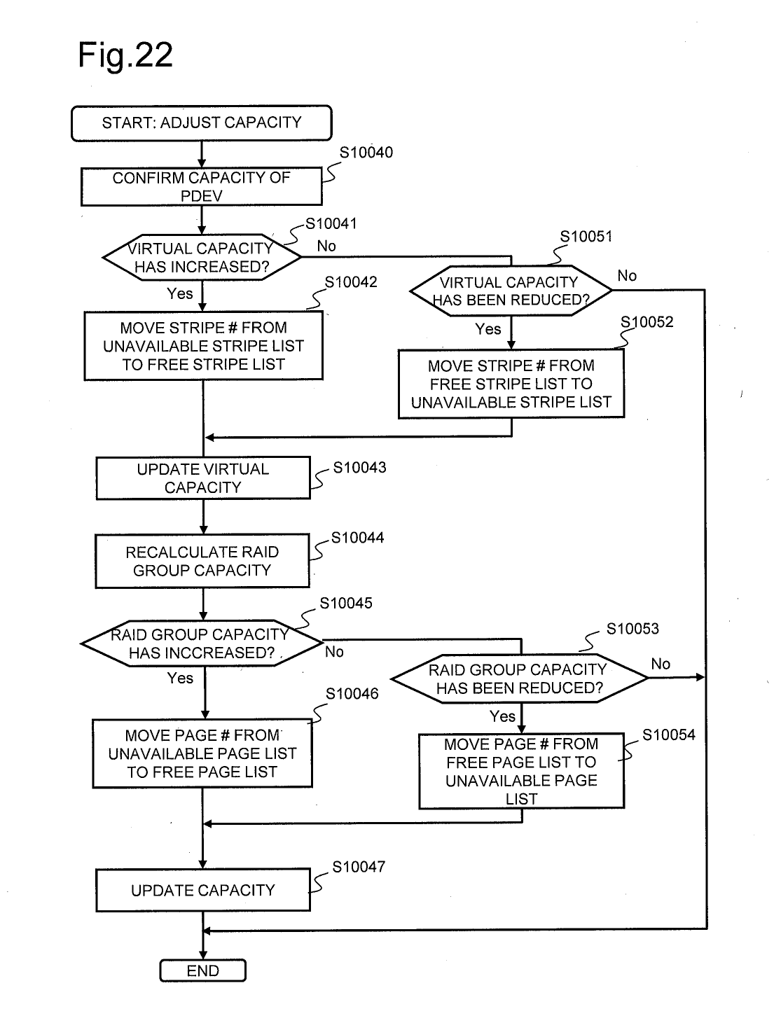

FIG. 13 is a view illustrating one example of contents of the pool management information 800. FIG. 13 (A) is a view showing one example of contents of the pool management information 800 prior to executing the capacity adjustment process (FIG. 22) described later, and FIG. 13 (B) is a view showing one example of contents of the pool management information 800 after executing the capacity adjustment process. FIG. 13 illustrates an example of the case where the capacity of the pool is increased by executing the capacity adjustment process.

The pool management information 800 includes the columns of a pool #806, a RAID group # (RG #) 801, an in-use page list 802, a free page list 803, an unavailable page list 804, an RG capacity 805, and a pool capacity 807. Each row (entry) represents information related to the RAID group belonging to the pool 45. The pool #806 is a field storing the identifiers of the pools, which are used to manage multiple pools when there are multiple pools. The RG #801 is a field storing the identifiers of the RAID groups. When a RAID group is added to the pool 45, an entry is added to the pool management information 800, and the identifier of the RAID group being added is stored in the RG #801 of the added entry.

A list of page numbers of physical pages within the RAID groups specified by the RG #801 in the used state (also referred to as pages in use), a list of page numbers of physical pages in vacant (unused) state (also referred to as free pages) and a list of physical page # of physical pages in an unavailable state (also referred to as unavailable pages) are stored in the in-use page list 802, the free page list 803 and the unavailable page list 804 of the respective entries. The meanings of “page in use”, “free page” and “unavailable page” are the same as in the case of the physical stripe. A page in use refers to the physical page mapped to the virtual page of the virtual volume. A free page refers to a physical page not yet mapped to the virtual page of the virtual volume, but can be mapped to a virtual page. An unavailable page refers to a physical page prohibited from being mapped to a virtual page. The reason why the information of the unavailable page list 804 is managed is the same as the reason described in the PDEV management information 700, that is, the capacity of the PDEV 17 may change dynamically, and the capacity of the RAID group may also change dynamically along therewith. Similar to the PDEV management information 700, the controller 11 adjusts the number of physical page # registered in the free page list 803 so that the sum of the total size of physical pages registered in the in-use page list 802 and the total size of the physical page registered in the free page list 803 become equal to the capacity of the RAID group (registered in the RG capacity 805 described later).

The RG capacity 805 is a field storing the capacity of the RAID group 5 specified by the RG #801. The pool capacity 807 is a field storing the capacity of the pool 45 identified by the pool #806. A total sum of the RG capacities 805 of all RAID groups included in the pool 45 identified by the pool #806 is stored in the pool capacity 807.

Next, we will describe the process flow of various programs in the storage 10. The letter “S” in the drawing represents steps.

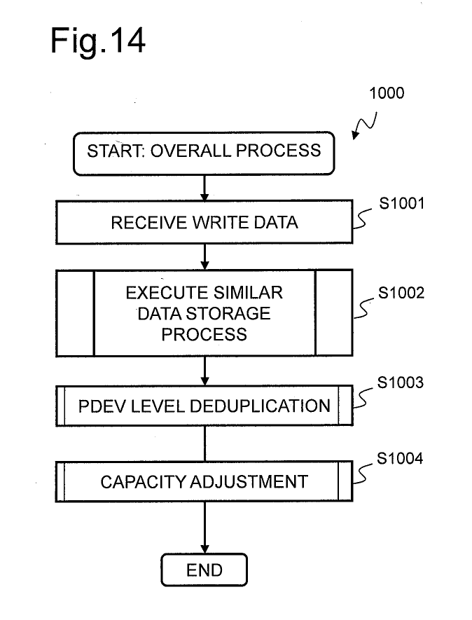

FIG. 14 shows an example of a flow of the process executed by the storage 10 when a write data is received from the host computer 20 (hereinafter referred to as overall process 1000).

S1001 and S1002 are executed by the CPU 18 in the controller 11. S1003 is executed by the CPU 172 in the PDEV 17. However, S1003 can be set to be executed by the CPU 18 of the controller 11. S1001 corresponds to FIG. 1 (1), S1002 corresponds to (2-1), (2-2) and (2-3), and S1003 corresponds to (3) of FIG. 1.

In S1001, the controller 11 receives a write data and a write destination address (virtual VOL # and write destination VBA of relevant virtual VOL) from the host computer 20, and stores the received write data in a cache memory area of the cache memory 12.

In S1002, the controller 11 executes the similar data storage processing described later.

In S1003, the PDEV 17 executes the PDEV-level deduplication described earlier. Various known methods can be adopted as the method of deduplication performed in the PDEV-level deduplication. One example of the processing will be described later.

In S1004, the capacity adjustment process of the pool 45 is performed. This is a process for enabling to provide increased storage areas to the host computer 20 when the storage areas of the PDEV 17 are increased by the deduplication process performed in S1003. The details of the process will be described later. Here, an example has been illustrated where the capacity adjustment process is executed in synchronization with the reception of the write data, but this process can also be executed asynchronously as the reception of the write data. For example, the controller 11 can be composed to execute the capacity adjustment process periodically.

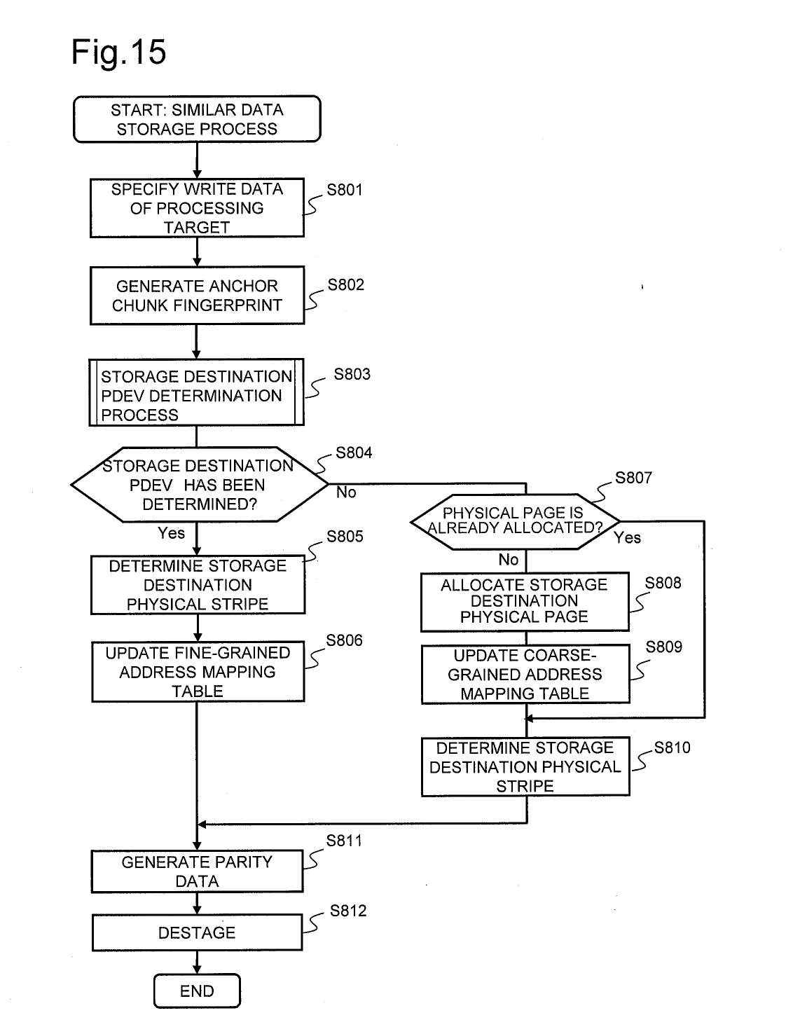

FIG. 15 is a view illustrating an example of a process flow of a similar data storage process. In S801, the controller 11 specifies the write data received in S1001 as the processing target write data. In the following description, the specified write data is referred to as a relevant write data. Further, the controller 11 calculates the virtual page # and the virtual stripe # from the write destination VBA of the relevant write data (hereinafter, the virtual page # (or virtual stripe #) being calculated is referred to as a write destination virtual page # (or virtual stripe #) of the relevant write data).

In S802, the controller 11 generates an anchor chunk fingerprint based on the relevant write data. Specifically, the controller 11 divides the relevant write data into chunks, and based on the data of the chunks, generates one or more anchor chunk fingerprints related to the write data. As mentioned earlier, with the aim to simplify the description, in the following description, the size of the relevant write data is assumed to be the same as the size of the physical stripe.

In S803, the controller 11 performs a storage destination PDEV determination process using the anchor chunk fingerprint generated in S802. The details of the storage destination PDEV determination process will be described later, but as a result of executing the storage destination PDEV determination process, a storage destination PDEV may or may not be determined. The process of S805 will be performed if the storage destination PDEV is determined (S804: Yes), and the process of S807 will be performed if the storage destination PDEV is not determined (S804: No).

In S805, the controller 11 determines the physical stripe being the write destination of the relevant write data (hereinafter referred to as storage destination physical stripe) out of the storage destination PDEVs determined in S803. The physical stripe set as the write destination is determined by the following steps. At first, whether unused physical stripes belonging to the storage destination PDEV determined in S803 exist or not in the unused stripe/PDEV list 654 of the page management table for fine-grained mapping 650 is confirmed, and when such stripes exist, one of the stripes is selected as the storage destination physical stripe. Then, the information of the selected storage destination physical stripe is moved from the unused stripe/PDEV list 654 to the used stripe/PDEV list 653.

When unused physical stripes belonging to the storage destination PDEV determined in S803 do not exist in the unused stripe/PDEV list 654, the controller 11 performs the following processes.

1) At first, one of the physical page # registered in the free page list 803 of the pool management information 800 is selected, and the selected physical page # is added to the in-use page list 802. Upon selecting a physical page #, the controller 11 sequentially selects the physical pages whose physical page # are smaller.

2) An entry (row) is added to the page management table for fine-grained mapping 650, and the physical page # being selected and the RAID group number to which the physical page # belongs (which can be acquired by referring to the RG #801) are registered in the page #652 and the RG #651 of the added entry. In the following description, the entry added here is referred to as a “processing target entry”.

3) Thereafter, the physical stripe # and the PDEV # to which the physical stripe belongs are specified for the respective physical stripes constituting the selected physical page. Since the physical page and the physical stripe are arranged regularly in the RAID group, the physical stripe # and the PDEV # of each physical stripe can be obtained via a relatively simple calculation.

4) The set of the physical stripe # and the PDEV # obtained by the above calculation is registered to the unused stripe/PDEV list 654 of the processing target entry.

5) At this point of time, the physical stripe # (and the PDEV #) specified in 3) is in the free stripe list 704 of the PDEV management information 700. Therefore, the physical stripe # specified in 3) is moved from the free stripe list 704 to the in-use stripe list 703 of the PDEV management information 700.

6) One physical stripe # belonging to the storage destination PDEV determined in S803 is selected from the physical stripe # registered in the unused stripe/PDEV list 654 of the page management table for fine-grained mapping 650 in the above step 4). This stripe is determined as the storage destination physical stripe, and the information of the storage destination physical stripe being determined is moved from the unused stripe/PDEV list 654 to the used stripe/PDEV list 653. The information of this determined physical stripe is registered to the fine-grained address mapping table 600 in the process performed in the subsequent step S806.

The controller 11 associates the determined physical stripe information (RAID group # and physical stripe #) to the virtual VOL # and the virtual page # of the write destination of the relevant write data, and registers the same in the fine-grained address mapping table 600 (S806). Further, in S806, the controller 11 registers the anchor chunk fingerprint in the index 300. Specifically, the anchor chunk fingerprint generated in S802 is registered to the anchor chunk fingerprint 301, the information of the physical stripes determined in S805 (PDEV # and PBA of physical stripe) is registered to the anchor chunk information 1 (302), and the virtual VOL # and the virtual page # which are the write destination of the relevant write data are registered to the anchor chunk information 2 (303). Further, it is possible to store all anchor chunk fingerprints generated in S802 or to store a portion of the anchor chunk fingerprints to the index 300.

When the storage destination PDEV is not determined in S804 (S804: No), the physical stripe being the write destination of the relevant write data is determined based on the coarse-grained address mapping table 500. By referring to the coarse-grained address mapping table 500, it is determined whether the physical page corresponding to the virtual page # calculated in S801 is already allocated or not. When a physical page is already allocated (S807: Yes), the controller 11 executes the process of S810. When the physical page is not allocated (S807: No), the controller 11 allocates one physical page from the unused physical pages registered in the free page list 803 of the pool management information 800 (S808), and registers the information of the physical page (and the RAID group to which the relevant physical page belongs) allocated in S808 to the coarse-grained address mapping table 500 (S809).

In S808, update of management information similar to the one performed in S805 will be performed. Specifically, processes 1), 3) and 5) are performed out of the processes of 1) through 6) described in S805. When selecting physical page # in S808, similar to S805, the physical pages having smaller physical page # are selected sequentially from the physical page # registered in the free page list 803 of the pool management information 800.

In S810, the controller 11 determines the physical stripe being the write destination of the relevant write data based on the coarse-grained address mapping table 500 and the fine-grained address mapping table 600. Specifically, whether there is an entry where the virtual VOL # (601) and the virtual stripe # (602) in the fine-grained address mapping table 600 are equal to the virtual VOL # and the virtual stripe # computed in S801 is confirmed, and when such corresponding entry is registered, the physical stripe specified by the RAID group # (603) and the physical stripe # (604) of the relevant entry is set as the physical stripe being the write destination of the relevant write data. In contrast, if the physical stripe corresponding to the virtual stripe # calculated in S801 is not registered in the fine-grained address mapping table 600, the physical stripe mapped (indirectly) to the virtual stripe # calculated in S801 by the coarse-grained address mapping table 500 is determined as the physical stripe being the write destination of the relevant write data. Similar to S806, information is also registered to the index 300 of the anchor chunk fingerprint.

In S811 and S812, destaging of the relevant write data is performed. Before destaging, the controller 11 performs RAID parity generation. The controller computes the parity to be stored in the parity stripe belonging to the same stripe array as the storage destination physical stripe to which the relevant write data is stored (S811). Parity calculation can be performed using a well-known RAID technique. After computing the parity, the controller 11 destages the relevant write data to the storage destination physical stripe, and further destages the computed parity to the parity stripe of the same stripe array as the storage destination physical stripe (S812), before ending the process.

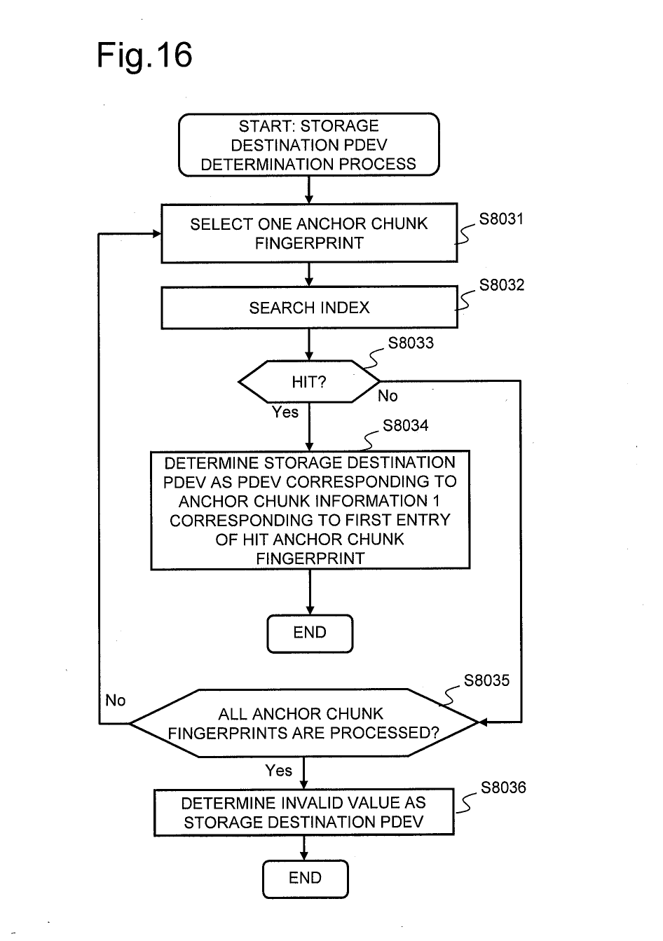

Next, the details of the storage destination PDEV determination process of S803 will be described with reference to FIG. 16. The storage destination PDEV determination process is implemented as a program called by the similar data storage process, as an example. By having the storage destination PDEV determination process executed, the PDEV # of the PDEV (storage destination PDEV) being the write destination of the relevant write data is returned (notified) to the similar data storage process which is the call source. However, if similar data of the relevant write data is not found as a result of executing the storage destination PDEV determination process, an invalid value is returned.

At first, the controller 11 selects one anchor chunk fingerprint generated in S802 (S8031), and searches whether the selected anchor chunk fingerprint exists in the index 300 or not (S8032).

When the selected anchor chunk fingerprint exists in the index 300, that is, when there exists an entry where the same value as the selected anchor chunk fingerprint is stored in the anchor chunk fingerprint 301 of the index 300 (hereinafter, this entry is referred to as a “target entry”) (S8033: Yes), the controller 11 determines the PDEV specified by the anchor chunk information 1 (302) of the target entry as the storage destination PDEV (S8034), and ends the storage destination PDEV determination process. In the present embodiment, the search of S8032 is performed sequentially from the initial entry in the index. Therefore, if multiple entries storing the same value as the selected anchor chunk fingerprint exist in the index 300, the entry searched first is set as the target entry.

If the selected anchor chunk fingerprint does not exist in the index 300 (S8033: No), the controller 11 checks whether the determination of S8033 has been performed for all the anchor chunk fingerprints generated in S802 (S8035). If there still exists an anchor chunk fingerprint where the determination of S8033 is not performed (S8035: No), the controller 11 repeats the processes from S8031 again. When the determination of S8033 is performed for all the anchor chunk fingerprints (S8035: Yes), the storage destination PDEV is determined to an invalid value (S8036), and the storage destination PDEV determination process is ended.

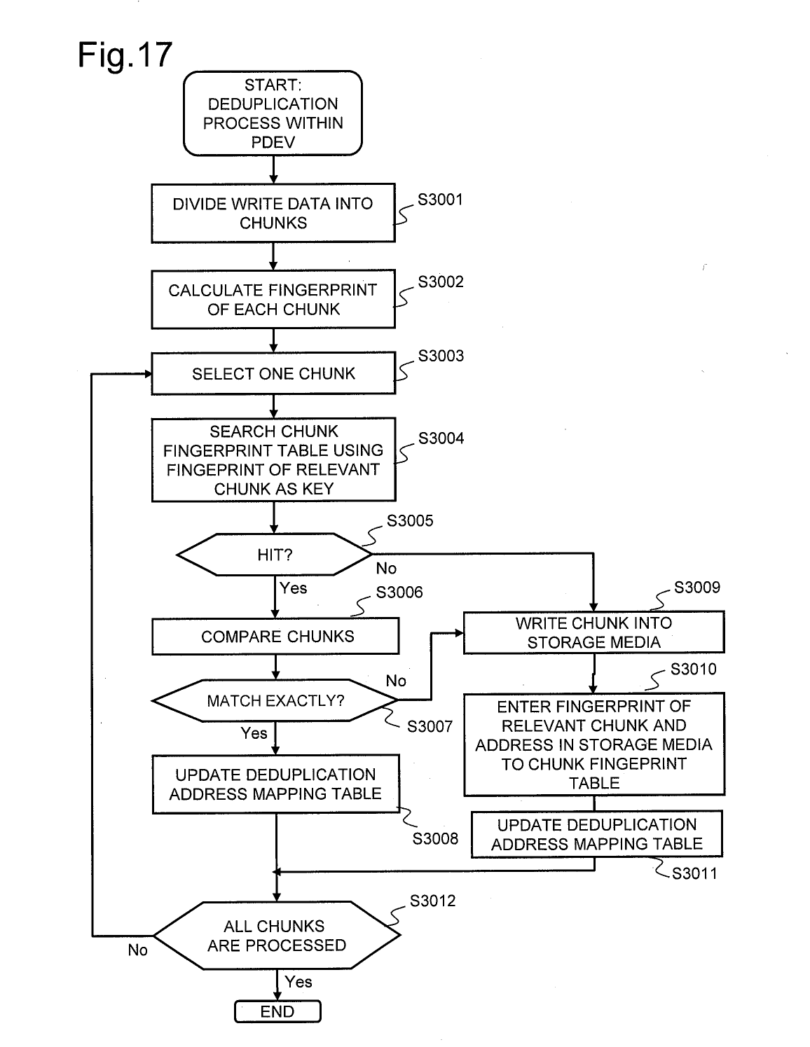

After the similar data storage process, as described in the description of FIG. 14, the PDEV-level deduplication process of S1003 is performed. The flow of the PDEV-level deduplication process will be described with reference to FIG. 17. This process is performed by the CPU 172 of the PDEV 17.

The PDEV 17 according to the present embodiment performs deduplication via chunk units, wherein the chunk has a fixed size. As shown in FIG. 18, the PDEV 17 divides the storage space provided to the controller 11 into chunk units, and assigns a unique identification number (called a chunk #) to each divided storage space for management. When the controller 11 issues an access request to the PDEV 17, it issues an access request designating the address of the storage space (LBA) provided by the PDEV 17 to the controller 11, wherein the CPU 172 of the PDEV 17 having received this access request is configured to convert the LBA into the chunk #.

Furthermore, the PDEV 17 also divides the storage area of the storage media 176 within the PDEV 17 into chunk units for management. In the initial state, that is, when no data is written thereto, the PDEV 17 records all the initial addresses of the respective divided areas in the free list 1105 stored in the memory 173. The free list 1105 is an assembly of addresses of the areas that have no data written thereto, that is, areas not mapped to the storage space provided to the controller 11. When the PDEV 17 writes the data subjected to a write request from the controller 11 to the storage media 176, it selects one or more areas from the free list 1105, and writes the data to the address of the selected area. Then, the address to which data has been written is mapped to a chunk #1101 and stored in an address in storage media 1102 in a duplicated address mapping table 1100.

In contrast, there may be a case where mapping of an area having been mapped to the storage space provided to the controller 11 is cancelled and the address of the area is returned to the free list 1105. This case may occur when data write (overwrite) occurs to the storage space provided to the controller 11. The details of these processes will be descried later.

Now, the information managed by the duplicated address mapping table 1100 will be described in detail. As shown in FIG. 18, the duplicated address mapping table 1100 is formed to include the columns of a chunk #1101, an address in storage media 1102, a backward pointer 1103, and a reference counter 1104. The respective rows (entries) of the duplicated address mapping table 1100 are management information of chunks in the storage space (called logical storage space) provided by the PDEV 17 to the controller 11. A chunk # assigned to the chunk in the logical storage space is stored in the chunk #1101. Hereafter, an entry whose chunk #1101 is n (that is, the management information of the chunk whose chunk # is n) is taken as an example to describe the other information.

In the following description, the following terms are used for specifying the chunks and respective elements in the duplicated address mapping table 1100.

a) A chunk whose chunk # is n is called “chunk # n”.

b) In the entries of the duplicated address mapping table 1100, the respective elements included in the entry whose chunk # (1101) is n (the address in storage media 1102, the backward pointer 1103 and the reference counter 1104) are each called “address in storage media 1102 of chunk #n”, “backward pointer 1103 of chunk #n”, and “reference counter 1104 of chunk #n”.

A position (address) information in the storage media storing the data of chunk # n is stored in the address in storage media 1102. When the contents of multiple chunks are the same, the same value is stored as the addresses in storage media 1102 of the respective chunks. For example, when referring to entries where the chunk #1101 is 0 and 3 in the duplicated address mapping table 1100 of FIG. 18, “A” is stored as the addresses in storage media 1102 of both entries. Similarly, when referring to entries where the chunk #1101 is 4 and 5, “F” is stored as the addresses in storage media 1102 of both entries. This means that the data stored in chunk #0 and chunk #3 are the same, and that the data stored in chunk #4 and chunk #5 and chunk #10 are the same.

When a chunk storing the same data as chunk #n exists, valid information is stored in the backward pointer 1103 and the reference counter 1104. One or more chunk # of chunk(s) storing the same data as chunk #n is stored in the backward pointer 1103. When there is no data equal to the data of chunk #n, an invalid value (NULL; a value that is not used as chunk #, such as −1) is stored in the backward pointer of chunk #n.

In principle, if a chunk storing the same data as chunk #n exists other than chunk #n (and assuming that the chunk # of that chunk is m), the counterpart chunk # is stored respectively in the backward pointer 1103 of chunk #n and the backward pointer 1103 of chunk #m. Therefore, m is stored in the backward pointer 1103 of chunk #n, and n is stored in the backward pointer 1103 of chunk #m.

On the other hand, if there are two or more chunks other than chunk #n storing the same data as chunk #n, the information to be stored in the backward pointer 1103 of the respective chunks is set as follows. Here, let the chunk # of the chunk whose chunk #1101 is smallest out of the chunks storing the same data be m. This chunk (chunk #m) is called a “representative chunk” in the following description. At this time, the chunk # of all the chunks storing the same data as chunk #m are stored in the backward pointer 1103 of chunk #m. Further, the chunk # of chunk #m (which is m) is stored in the backward pointer 1103 of each chunk storing the same data as chunk #m (excluding chunk #m).

In FIG. 18, an example is illustrated where the same data are stored in chunks whose chunk #1101 are 4, 5 and 10. At this time, since 4 is the smallest number of numbers 4, 5 and 10, the chunk #4 is set as the representative chunk. Therefore, 5 and 10 are stored in the backward pointer 1103 of chunk #4 as the representative chunk. On the other hand, only the chunk # of the representative chunk (which is 4) is stored in the backward pointer 1103 whose chunk #1101 is 5. The backward pointer 1103 whose chunk #1101 is 10 is not shown in the drawing, but only the chunk # of the representative chunk (which is 4) is stored, similar to in the backward pointer 1103 whose chunk #1101 is 5.

The value of (the number of chunks storing the same data−1) is stored in the reference counter 1104. However, a valid value is stored in the reference counter 1104 only when the chunk is the representative chunk. As for chunks other than the representative chunk, 0 is stored in the reference counter 1104.

As mentioned above, FIG. 18 illustrates an example where the same data is stored in chunks (three chunks) whose chunk #1101 are 4, 5 and 10. In this case, 2 (=3−1) is stored in the reference counter 1104 of chunk #4 being the representative chunk. In the reference counter 1104 of other chunks (chunk #5, and chunk #10, although not shown in FIG. 18), 0 is stored. Further, regarding chunks having no other chunks storing the same data, 0 is stored in the reference counter 1104.

In the following description, the flow of the PDEV-level deduplication processing will be described, taking a case as an example where the PDEV 17 receives a data of a size corresponding to a single physical stripe size from the controller 11. At first, the CPU 172 divides the data received from the controller 11 into multiple chunks (S3001), and computes the fingerprint of each chunk (S3002). After computing the fingerprint, the CPU 172 associates the chunk, the chunk # storing the chunk and the fingerprint calculated from the chunk, and temporarily stores the same in the memory 173.

Thereafter, the CPU 173 selects one chunk from the chunks being divided and generated in S3001 (S3003). Then, it checks whether the fingerprint equal to the fingerprint corresponding to the selected chunk is registered in a chunk fingerprint table 1200 or not (S3004).

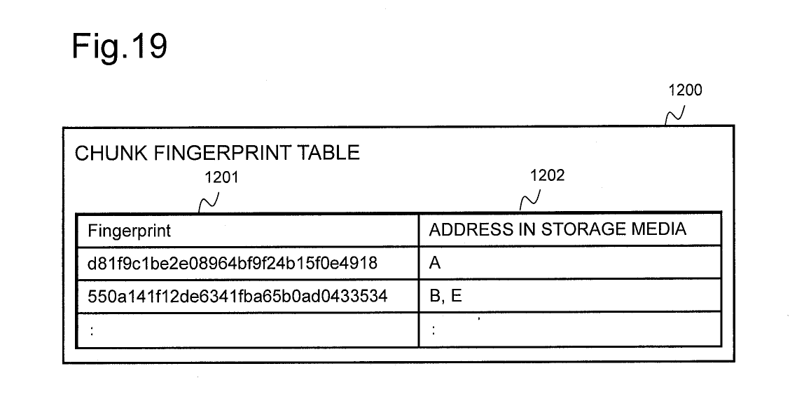

The chunk fingerprint will be described with reference to FIG. 19. The chunk fingerprint table 1200 is a table stored in the memory 173, similar to the duplicated address mapping table 1100. In the chunk fingerprint table 1200, the value of the chunk fingerprint generated from the data (chunk) stored in the area specified by the address in the storage media (1202) is stored in the fingerprint (1201). In S3004, the CPU 173 checks whether an entry having the same fingerprint as the selected chunk stored in the value of the fingerprint (1201) exists in the chunk fingerprint table 1200 or not. If there is an entry having the same fingerprint (1201) as the fingerprint corresponding to the selected chunk, this state is referred to as “hitting a fingerprint”, and this entry is called a “hit entry”.

When a fingerprint is hit (S3005: Yes), the CPU 174 reads data (chunk) from the address in the storage media 1202 of the hit entry, and compares the same with the selected chunk (S3006). In the present comparison, the CPU 174 uses the comparator circuit 174 to determine whether all the bits of the selected chunk and the read data (chunk) are equal or not. Further, there are cases where multiple addresses are stored in the address in the storage media (1202). In that case, the CPU 174 reads the data (chunk) from multiple addresses and performs comparison with the selected chunk.

As a result of comparison in S3006, if the selected chunk and the read data (chunk) are the same (S3007: Yes), there is no need to write the selected chunk into the storage media 176. In this case, in principle, it is only necessary to update the duplicated address mapping table 1100 (S3008). As an example, we will describe the process performed in S3008 in a case where the chunk # of the selected chunk is 3, and the address in the storage area storing the same data as the selected chunk is “A” (address in storage media mapped to chunk #0). In this case, in S3008, “A” is stored in the address in storage media 1102 of the entry whose chunk # (1101) is 3 out of the entries of the duplicated address mapping table 1100. No data (data duplicated with chunk #0) will be written to the storage media 176. The details of the update processing of the duplicated address mapping table 1100 will be described later.

On the other hand, if the determination result of S3005 is negative, or if the determination result of S3007 is negative, the CPU 172 selects an unused area of the storage media 176 from the free list 1105, and stores the selected chunk in the selected area (S3009). Further, the CPU 172 registers the address of the storage media 176 being the storage destination of the selected chunk and the fingerprint of the relevant chunk in the chunk fingerprint table 1200 (S3010). Thereafter, it updates the deduplication address mapping table 1100 (S3011). In S3011, an address of the area storing the chunk in S3009 is stored in the address in storage media 1102 of the entry whose chunk # (1101) is the same chunk number as the selected chunk.

When the processes of S3003 through S3011 have been completed for all the chunks (S3012: Yes), the PDEV deduplication processing is ended. If there still remains a chunk where the processes of S3003 through S3011 are not completed (S3012: No), the CPU 172 repeats the processes from S3003.

Next, the process of S3008 mentioned above, that is, the flow of the update processing of the duplicated address mapping table 1100 will be described. This process is implemented, as an example, as a program called by the deduplication processing in the PDEV (hereinafter, this program is called mapping table update program). By having the mapping table update program executed by the CPU 172, the duplicated address mapping table 1100 is updated. In the process of FIG. 17, it is also possible to only call step S3008 as the “deduplication process”.

A case where the mapping table update program is called when executing S3008 is when a chunk (hereinafter called a duplicated chunk) having the same contents as the chunk selected in S3003 exists in the storage media 176. When the CPU 172 calls the mapping table update program, it hands over the chunk # of the chunk selected in S3003, the chunk # of the duplicated chunk and the address in the storage media of the duplicated chunk to the mapping table update program as arguments.

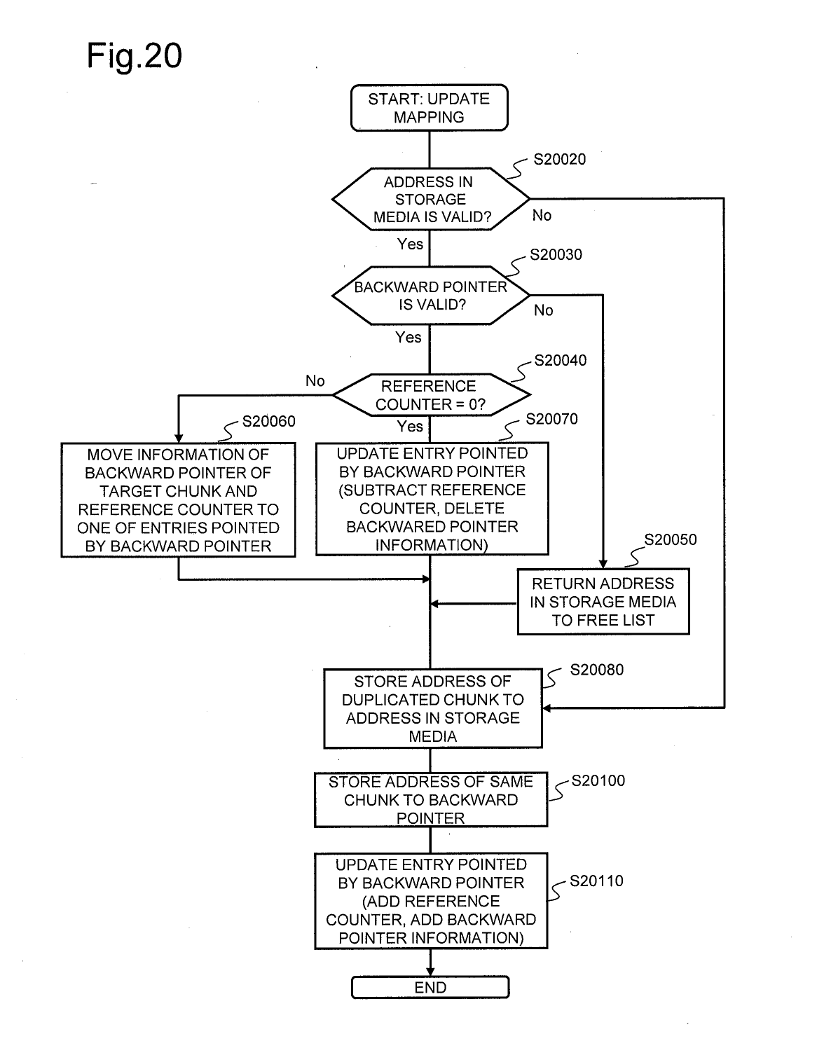

Hereafter, the process flow of the mapping table update program will be described with reference to FIG. 20. In the following process, an example is described where the chunk # of the chunk selected in the process of S3003 is k. At first, the CPU 172 determines whether a valid value is stored in the address in storage media 1102 of chunk #k or not (S20020). When a valid value is not stored therein (S20020: No), the CPU 172 will not execute processes S20030 through S20070, and only executes the process of S20080. The processes of S20080 and thereafter will be described in detail later.

If a valid value is stored therein (S20020: Yes), the CPU 172 determines whether a valid value is stored in the backward pointer 1103 of chunk #k or not (S20030). If a valid value is not stored therein (S20030: No), the CPU 172 returns the address in storage media 1102 of chunk #k to the free list 1105 (S20050). On the other hand, if a valid value is stored (S20030: Yes), the CPU 172 determines whether the reference counter 1104 of chunk #k is 0 or not (S20040).

If the reference counter 1104 of chunk #k is 0 (S20040: Yes), the CPU 172 updates the entry related to the chunk specified by the backward pointer 1103 of chunk #k. For example, if k is 3 and the state of the duplicated address mapping table 1100 is in a state as shown in FIG. 18, the backward pointer 1103 of chunk #3 is 0. In that case, the entry whose chunk # (1101) is 0 in the duplicated address mapping table 1100 is updated. Specifically, the CPU 172 subtracts 1 from the value of the reference counter 1104 of chunk #0. Further, since the information of chunk #3 (3) is at least included in the backward pointer 1103 of chunk #0, so that this information (3) is deleted.

If the reference counter 1104 of chunk #k is not 0 (S20040: No), the CPU 172 moves the information of the backward pointer 1103 of chunk #k and the reference counter 1104 of chunk #k to a different chunk. For example, a case where k is 4 and the state of the duplicated address mapping table 1100 is in the state as shown in FIG. 18 will be described below.

By referring to FIGS. 18, 5 and 10 are stored in the backward pointer 1103 of chunk #4, and 2 is stored in the reference counter 1104. In this case, the information of the backward pointer 1103 and the reference counter 1104 are moved to the chunk having the smallest number (that is, chunk #5) out of the chunk # stored in the backward pointer 1103 of chunk #4. However, in this movement, 5 (own chunk #) will not be stored in the backward pointer 1103 of chunk #5. Further, the value stored in the reference counter 1104 of chunk #5 is a value having 1 subtracted from the value stored in the reference counter of chunk #4 (since chunk #4 is updated and data that is not equal to chunk #5 may be stored therein). As a result, 10 is stored in the backward pointer of chunk #5, and 1 is stored in the reference counter 1104 thereof.

After S20050, S20060 or S20070, the CPU 172 stores the address in the storage media handed over as argument into the address in storage media 1102 of chunk #k (address in storage media of the duplicated chunk; it is also the address in the storage media of the chunk selected in S3003 (S20080).

Thereafter, the CPU 172 stores the chunk # of the duplicated chunk (handed over as argument) to the backward pointer 1103 of chunk #k (S20100). At the same time, the CPU 172 stores 0 in the reference counter 1104 of chunk #k. Then, the CPU 172 registers k (chunk #k) in the backward pointer 1103 of the duplicated chunk, adds 1 to the value in the reference counter 1104 of the duplicated chunk (S20110), and ends the process.

Next, we will describe the flow of the process of S3011 mentioned above. This process has many points in common with the process described with reference to FIG. 20, so only the differences from the process illustrated in FIG. 20 will mainly be described. Similar to the process of FIG. 20, the present process is implemented as a program (hereinafter this program will be called “mapping table second update program”) called from the deduplication process in the PDEV. Execution of the above step S3011 is performed when there is no chunk (duplicated chunk) having the same contents as the chunk selected in S3003 in the storage media 176. In that case, when the CPU 172 calls the mapping table second update program, it hands over the chunk # of the chunk selected in S3003 and the address in the storage media of the chunk selected in S3003 (address of the unused area selected in S3009) as arguments to the mapping table second update program.

The flow of the process of the mapping table second update program is substantially the same as the process of FIG. 20 from S20020 through S20080. However, the difference is that in S20080, the address stored in the address in storage media 1102 of chunk #k is the address of the unused area selected in S3009.

After S20080, instead of performing S20100 and S20110 of FIG. 20, the CPU 172 stores NULL in the backward pointer 1103 of chunk #k, and 0 in the reference counter 1104 thereof. By performing this process, the mapping table second update program is ended.

An example has been illustrated of the case where the PDEV 17 has a function to perform the deduplication process, but as another embodiment, a configuration can be adopted where the deduplication process is performed in the controller 11. In that case, the chunk fingerprint table 1200, the free list 1105 and the deduplication address mapping table 1100 are prepared for each PDEV 17, and stored in the shared memory 13 or a local memory of the controller 11. Further, the address of the PDEV 17 (address in the storage space provided by the PDEV 17 to the controller 11) is stored in the address in storage media 1202 of the chunk fingerprint table 1200, and the address in storage media 1102 of the deduplication address mapping table 1100.

The CPU 18 of the controller 11 executes the deduplication process using the chunk fingerprint table 1200 and the deduplication address mapping table 1100 stored in the shared memory 13 or the local memory of the controller 11. When the CPU 18 executes the deduplication process, the flow of the process is the same as the flow described in FIG. 17, except for S3009. When the CPU 18 executes the deduplication process, in S3009, the CPU 18 operates to store the selected chunk in the unused area of the PDEV 17 in place of the unused area of the storage media 176.

Next, the flow of the process (hereinafter called “capacity returning process”) for the PDEV 17 to return the storage capacity to the controller 11 will be described. This process is performed by the CPU 172 within the PDEV 17. In this process, the deduplication rate (described later) is recognized to determine whether there is a need to change the virtual capacity of the PDEV 17 or not. When it is determined that change is necessary, the capacity is determined and the determined capacity is returned to the controller 11.

At first, the management information required for the process and which is managed by the PDEV 17 (management information within PDEV) is described with reference to FIG. 18. In addition to the deduplication address mapping table 1100, the chunk fingerprint table 1200 and the free list 1105, the PDEV 17 stores a management information within PDEV 1110 in the memory 173 for management.

A virtual capacity 1111 is the size of the storage space that the PDEV 17 provides to the controller 11, wherein this virtual capacity 1111 is notified from the PDEV 17 to the controller 11. In the initial state, a value greater than an actual capacity 1113 described later is stored. However, as another embodiment, it is possible to have a value equal to the actual capacity 1113 stored in the virtual capacity 1111. In the example of the management information within PDEV 1110 illustrated in FIG. 18, the virtual capacity 1113 is 4.8 TB. By the process of S18003 in FIG. 12 described later, the value of virtual capacity 1113 is set based on the following calculation: “virtual capacity 1113=actual capacity 1113×deduplication rate (δ)=actual capacity 1113×virtual amount of stored data 1112÷amount of stored data after deduplication 1114”.

The virtual amount of stored data 1112 is the quantity of area where data from the controller 11 has been written out of the storage space provided by the PDEV 17 to the controller 11. For example, in FIG. 18, if data write has been performed from the controller 11 to four chunks from chunk 0 to chunk 3, but the other areas are not accessed at all, the virtual amount of stored data 1112 will be four chunks (16 KB, when one chunk is 4 KB). In other words, the virtual amount of stored data 1112 is the amount of data (size) before performing deduplication of the data stored in the PDEV 17. In the example of the management information within PDEV 1110 illustrated in FIG. 18, the virtual amount of stored data 1112 is 3.9 TB.

The actual capacity 1113 is a total size of multiple storage media 176 installed in the PDEV 17. This value is a fixed value determined uniquely based on the storage capacity of the respective storage media 176 installed in the PDEV 17. In the example of FIG. 18, the actual capacity 1113 is 1.6 TB.

The amount of stored data after deduplication 1114 is the amount of data (size) after performing deduplication processing to the data stored in the PDEV 17. One example thereof will be described with reference to FIG. 18. If data is written from the controller 11 to four chunks from chunk 0 to chunk 3, wherein the data of chunk 0 and chunk 3 are the same, by the deduplication process, only the data of the chunk 0 is written to the storage media 176, and the data of the chunk 3 will not be written to the storage media 176. Therefore, the amount of stored data after deduplication 1114 of this case will be three chunks (12 KB, when one chunk is 4 KB). In the example of FIG. 18, the amount of stored data after deduplication 1114 is 1.3 TB. In this example, it is shown that data of 2.6 TB (=3.9 TB−1.3 TB) has been reduced by deduplication.

The virtual amount of stored data 1112 and the amount of stored data after deduplication 1114 are calculated by the capacity returning process described below. These values are calculated based on the contents of the deduplication address mapping table 1100. The virtual amount of stored data 1112 can be calculated by counting the number of rows storing a valid value (non-NULL value) in the address in storage media 1102 out of the respective rows (entries) of the deduplication address mapping table 1100. Further, the amount of stored data after deduplication 1114 can be calculated by counting the number of rows excluding the rows storing duplicated values out of the rows storing valid values (non-NULL values) in the address in storage media 1102 within the deduplication address mapping table 1100. Specifically, the entry having a non-NULL value stored in the backward pointer 1103 but having value 0 stored in the reference counter 1104 is an entry regarding a chunk whose contents are duplicated with the contents of other entries (chunks specified by the backward pointer 1103), so that such entry should not be counted. In other words, the total number of entries where the backward pointer 1103 is NULL and the entries where a non-NULL value is stored in the backward pointer 1103 and a value of 1 or greater is stored in the reference counter 1104 should be counted.

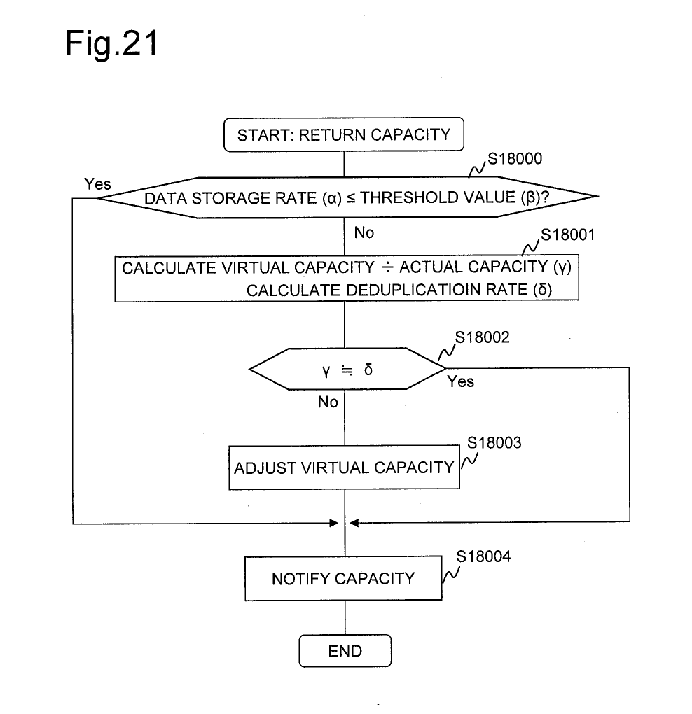

Now, the flow of the capacity returning process will be described with reference to FIG. 21.

S18000: At first, the CPU 172 uses the above-described method to calculate the virtual amount of stored data and the amount of stored data after deduplication, and stores the respective values in the virtual amount of stored data 1112 and the amount of stored data after deduplication 1114. Thereafter, the CPU 172 calculates virtual amount of stored data 1112÷virtual capacity 1111. Hereinafter, this calculated value is called α (value α is also called “data storage rate”). When value α is equal to or smaller than β (β is a sufficiently small constant value), not much data is stored therein, so the process is ended.

S18001: Next, the value of virtual capacity 1111÷actual capacity 1113 is calculated. In the following description, this value is called γ. Further, the value of virtual amount of stored data 1112÷amount of stored data after deduplication 1114 is calculated. In the following description, this value is called δ. In the present specification, value δ is also referred to as the deduplication rate.

S18002: Comparison of γ and δ is performed. If γ and δ are substantially equal, for example, in a relationship satisfying (δ−threshold 1)≦γ<(δ+threshold 2) (wherein threshold 1 and threshold 2 are constants having a sufficiently small value; threshold 1 and threshold 2 may be equal or different), it can be said that an ideal virtual capacity 1111 is set. Therefore, in that case, the virtual capacity 1111 will not be changed, and the current value of the virtual capacity 1111 is notified to the controller 11 (S18004), before the process is ended.

On the other hand, in the case of γ>(δ+threshold 2) (which can be stated as a case where the virtual capacity 1111 is too large), or in the case of γ<(δ−threshold 1) (which can be stated as a case where the virtual capacity 1111 is too small), the procedure advances to S18003, where the virtual capacity 1111 is changed.

S18003: The virtual capacity is changed. Specifically, the CPU 172 computes the actual capacity 1113×δ, and the value is stored in the virtual capacity 1111. Then, the value stored in the virtual capacity 1111 is notified to the controller 11 (S18004), and the process is ended.

If the deduplication rate δ does not change in the future, the PDEV 17 can store the amount of data equivalent to this value (actual capacity 1113×δ), so that this value is an ideal value as the virtual capacity 1111. However, as another preferred embodiment, it is possible to set up a value other than this value as the virtual capacity 1111. For example, it is possible to adopt a method where (actual capacity 1113−amount of stored data after deduplication 1114)×γ+amount of stored data after deduplication 1114×δ is set as the virtual capacity.

In the above description, an example is described where the value of the virtual capacity 1111 is notified to the controller 11 in the process of S18004, but it is possible to have information other than the value of the virtual capacity 1111 returned to the controller 11. For example, it is possible to return, in addition to the virtual capacity 1111, at least one or more of the virtual amount of stored data 1112, the actual capacity 1113 and the amount of stored data after deduplication 1114 to the controller 11.

The determination of S18000 may not be necessarily performed. In other words, the PDEV 17 may return the capacity information (virtual capacity 1111, virtual amount of stored data 1112, actual capacity 1113 or amount of stored data after deduplication 1114), regardless of the level of data storage rate. Further, δ (deduplication rate) can be returned.

As another embodiment, in addition to the function of the capacity returning process (FIG. 21), the PDEV 17 can have a function to compute only the δ (deduplication rate) and to return the same when an inquiry of deduplication rate is received from the controller 11. In that case, when the PDEV 17 receives an inquiry request of deduplication rate from the controller 11, it calculates the virtual amount of stored data 1112 and the amount of stored data after deduplication 1114, and also executes the process corresponding to S18001 of FIG. 21, before returning δ to the controller 11. The information returned to the controller 11 can either be only δ, or include information other than δ.

The above description has described the flow of the process when the capacity returning process is executed in the PDEV 17. If the PDEV 17 does not perform the deduplication process, the controller 11 will execute the process described above. In that case, the storage 10 must prepare management information within PDEV 1110 for each PDEV 17, and store the same in the shared memory 13 and the like.

Next, the process of S1004, that is, the capacity adjustment process of the pool, will be described with reference to FIG. 22. The controller 11 confirms the virtual capacity of the PDEV 17 by issuing a capacity inquiry request to the PDEV 17 (S10040). When the controller 11 issues a capacity inquiry request to the PDEV 17, the PDEV 17 executes the process of FIG. 21, and transmits the virtual capacity 1111 to the controller 11.

The PDEV 17 to which the capacity inquiry request is issued in S10040 can be all the PDEVs 17 within the storage subsystem 10, or only the PDEV to which the similar data storage process has been executed in S1002 (more precisely, the PDEV to which data or parity has been destaged in S812). In the following description, an example has been described where a capacity inquiry request is issued to PDEV #n (PDEV 17 whose PDEV # is n) in S10040.

Thereafter, the controller 11 compares the virtual capacity notified from the PDEV #n (or the virtual capacity computed based on the information notified from PDEV #n) and the virtual capacity 702 of PDEV #n (virtual capacity 702 stored in the entry whose PDEV #701 is “n” out of the entries of the PDEV management information 700), and determines whether the virtual capacity of PDEV #n has increased or not (S10041). In this determination, the controller 11 calculates

(virtual capacity notified from PDEV#n−virtual capacity 702 of PDEV#n),

and converts the result into the number of physical stripes. When converting the result into the number of physical stripes, the numbers below decimal point are rounded off. If the number of physical stripes calculated here is 1 or greater, the controller 11 determines that the virtual capacity of PDEV #n has increased.

If the virtual capacity of PDEV #n has increased (S10041: Yes), the number of free stripes can be increased to a number equal to the number of physical stripes calculated above. The controller 11 selects a number of physical stripe #s equal to the number of physical stripes calculated above from the unavailable stripe list 705 of PDEV #n, and moves the selected physical stripe # to the free stripe list 704 of PDEV #n (S10042). When selecting the physical stripe # to be moved, arbitrary physical stripe # within the unavailable stripe list 705 can be selected, but according to the present embodiment, the physical stripe # having the smallest physical stripe # is selected sequentially in order from the physical stripe #s of the unavailable stripe list 705. When the virtual capacity of the PDEV #n is not increased (S10041: No), the process of S10051 is performed.

In S10051, the process opposite to S10041, that is, whether the virtual capacity of PDEV #n has been reduced or not is determined. The determination method is similar to S10041. The controller 11 calculates (virtual capacity 702 of PDEV #n−virtual capacity notified from PDEV #n), and converts this into the number of physical stripes. However, when a fraction smaller than the decimal point is generated by converting the result into the number of physical stripes, the value is rounded up. If the calculated number of physical stripes is equal to or greater than a given value, for example, equal to or greater than 1, the controller 11 determines that the virtual capacity of PDEV #n has reduced.

If the virtual capacity of PDEV #n has been reduced (S10051: Yes), the free stripe number must be reduced for a value equal to the calculated physical stripe number. The controller 11 selects a number of physical stripe #s equal to the number of physical stripes calculated above from the free stripe list 704 of PDEV #n, and moves the selected physical stripe #s to the unavailable stripe list 705 of PDEV #n. Upon selecting the physical stripe #s to be moved, it is possible to select arbitrary physical stripe #s within the free stripe list 704, and according to the present embodiment, the physical stripe # having a greater value is selected sequentially in order from the physical stripe #s in the free stripe list 704. If the virtual capacity of PDEV #n has not been reduced (S10051: No), the process is ended.

In S10043, the controller 11 updates the virtual capacity 702 of PDEV #n (stores the virtual capacity returned from the PDEV #n). Thereafter, in S10044, recalculation of the capacity of the RAID group to which the PDEV #n belongs is executed. By referring to the RAID group management information 200, the controller 11 specifies the RAID group to which the PDEV #n belongs and all PDEVs 17 belonging to the RAID group. In the following description, the RAID group to which the PDEV #n belongs is called a “target RAID group”. By referring to the PDEV management information 700, the minimum value of the virtual capacity 702 of all PDEVs 17 belonging to the target RAID group is obtained.

The upper limit of the number of stripe arrays that can be formed within a RAID group is determined by the virtual capacity of the PDEV having the smallest virtual capacity out of the PDEVs belonging to the RAID group. The physical page is composed of (physical stripes within) one or multiple stripe arrays, so that the upper limit of the number of physical pages that can be formed within a single RAID group can also be determined based on the virtual capacity of the PDEV having the smallest virtual capacity out of the PDEVs belonging to that RAID group. Therefore, in S10044, the smallest value of the virtual capacity 702 of all PDEVs 17 belonging to the target RAID group is obtained. Based on this value, the upper limit value of the number of physical pages that can be formed in the target RAID group is calculated, and the calculated value is determined as the capacity of the target RAID group. As an example, when a single physical page is composed of (physical stripes within) p number of stripe arrays, and when the minimum value of the virtual capacity 702 of the PDEV 17 belonging to the target RAID group is s (s is a value after having converted the unit (GB) of the virtual capacity 702 into the number of physical stripes), the capacity of the target RAID group (the number of physical pages) is (s÷p). Hereafter, the value calculated here is called a “post-change RAID group capacity”. On the other hand, the capacity of the target RAID group prior to executing the present process (capacity adjustment process of the pool) is stored in the RG capacity 805 of the pool management information 800. The value stored in the RG capacity 805 is called a “pre-change RAID group capacity”.

In S10045, the controller 11 compares the post-change RAID group capacity and the pre-change RAID group capacity, and determines whether the capacity of the target RAID group has increased or not. Similar to S10041, this determination process determines the number of physical pages that can be increased, by calculating

(post-change RAID group capacity−pre-change RAID group capacity).

If the determined value is equal to or greater than a given value, that is, equal to or greater than one physical page, the controller 11 determines that the capacity has increased.

When the capacity of the target RAID group is increased (S10045: Yes), the number of free pages of the target RAID group managed by the pool management information 800 can be increased. The controller 11 selects the same number of physical page #s as the calculated number of the physical pages that can be increased from the unavailable page list 804 of the target RAID group, and moves the selected physical page #s to the free page list 803 (S10046). Upon selecting the physical page #s to be moved, the physical page whose physical stripes constituting the physical page are all registered to the vacant stripe list 704 out of the physical pages in the unavailable page list 804 is set as the target. When the capacity of the target RAID group has not been increased (S10045: No), the process of S10053 will be performed.

In S10053, the number of reduced physical pages is determined by performing the process opposite to S10045, that is, by calculating (pre-change RAID group capacity−post-change RAID group capacity). If the determined value is equal to or greater than a given value, that is, equal to or greater than a single physical page, the controller 11 determines that the capacity has been reduced. If the capacity of the target RAID group has been reduced (S10053: Yes), it is necessary to reduce the number of free pages of the target RAID group managed by the pool management information 800.

The controller 11 selects the same number of physical page #s as the number of reduced physical pages calculated above from the free page list 803 of the target RAID group, and moves the selected physical page #s to the unavailable page list 804 (S10054). Upon selecting the physical page #s to be moved, according to the present embodiment, the physical page including the physical stripes having been moved to the unavailable stripe list 705 in S10052 out of the physical page # in the free page list 803 is selected.

When the capacity of the target RAID group has not been reduced (S10053: No), the process is ended. Instead of executing the determination of S10053, it is also possible to determine whether the physical page composed of the physical stripes moved to the unavailable stripe list 705 in S10052 is included in the physical page # within the free page list 803 or not, and to move the determined physical page to the unavailable page list 804.

After the process of S10046 or S10054 is performed, at last, the controller 11 updates the capacity of the target RAID group (the RG capacity 805 of the pool management information 800) to the post-change RAID group capacity calculated in S10044, updates the pool capacity 807 accompanying the same (S10047), and ends the process. By performing this capacity adjustment process after the deduplication process of PDEV 17, when the capacity (virtual capacity) of the PDEV 17 is increased, the number of free pages of the RAID group belonging to the pool 45 is also increased (and the free stripe number is also increased). In other words, by performing the capacity adjustment process after executing the deduplication process, an effect is achieved where the vacant storage areas (physical pages or physical stripes) that can be mapped to the virtual volume are increased.

The present embodiment has been described assuming that the capacity adjustment process of FIG. 22 is executed in synchronization with the reception of write data (S1001), but the capacity adjustment process can be executed asynchronously as the reception of write data (S1001). For example, it is possible to have the controller 11 periodically perform the capacity adjustment process.

The above embodiment has been described taking as an example a case where, as a result of issuing the inquiry request of capacity to the PDEV #n in S10040, the virtual capacity (virtual capacity 1111 that PDEV#n manages by the management information within PDEV 1110) is received from the PDEV #n. However, the information received from PDEV #n is not restricted to the virtual capacity 1111. In addition to the virtual capacity 1111, the virtual amount of stored data 1112, the actual capacity 1113 and the amount of stored data after deduplication 1114 can be included in the information.

Further, other information capable of deriving the virtual capacity of PDEV#n may be received instead of the virtual capacity. For example, it is possible to have the actual capacity 1113 and the deduplication rate (δ) received. In this case, the controller 11 calculates the virtual capacity by calculating “actual capacity 1113×deduplication rate (δ)”. Further, since the actual capacity 1113 is a non-varied value, the storage 10 can receive the actual capacity 1113 during installation of the PDEV#n, store the same in the shared memory 13 and the like, and receive only the deduplication rate (δ) in S10040.

Further, the controller 11 may receive the physical free capacity (capacity calculated from the total number of chunks registered to the free list 1105), the deduplication rate (δ) and the actual capacity 1113 from the PDEV #n. In this case, the controller 11 calculates the value corresponding to the virtual capacity by calculating “actual capacity 1113×deduplication rate (δ)”, calculates the value corresponding to the amount of stored data after deduplication 1114 by calculating “actual capacity 1113−physical free capacity”, and calculates the value corresponding to the virtual amount of stored data 1112 by calculating “(actual capacity 1113−physical free capacity)×deduplication rate (δ)”.

The above description has illustrated the write processing performed in the storage subsystem 10 according to Embodiment 1. According to the storage subsystem 10 of Embodiment 1, the PDEV in which the physical stripes including the similar data of the write target data is found, and the write target data is stored in the PDEV, so that the deduplication rate during deduplication processing performed in the PDEV level can be improved.

The storage destination PDEV of write data (user data) from the host computer 20 written to the respective addresses in the virtual volume by this process varies depending on the contents of the write data, so in S805, the storage destination physical stripe (that is, the storage destination PDEV) of the relevant write data is determined, the parity data related to the storage destination physical stripe is generated, and the user data and the parity data are stored in different PDEVs 17. Therefore, though the write destination of user data can be varied dynamically, the redundancy of data will not be lost, and the data can be recovered even during PDEV failure.

### Modified Example 1

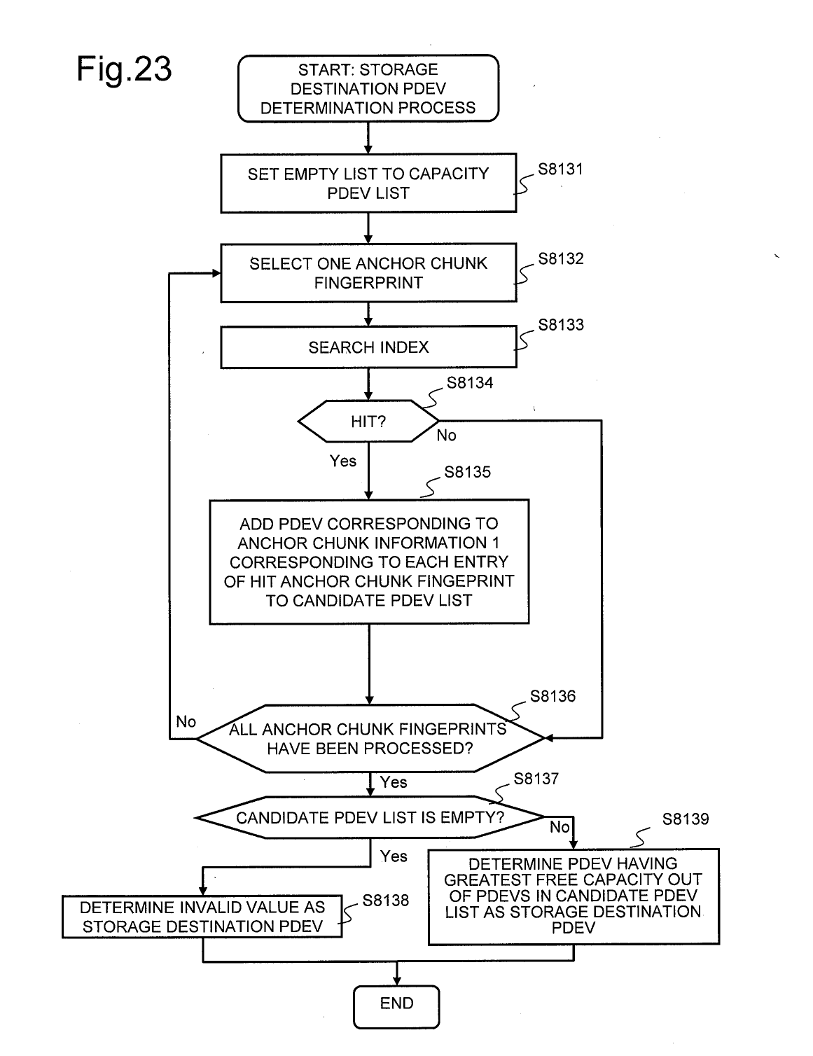

Various modified examples can be considered for the storage destination PDEV determination process (S803) described above. In the following description, the various modified examples of the storage destination PDEV determination process (S803) according to Modified Example 1 and Modified Example 2 will be described. FIG. 23 is a flowchart of the storage destination PDEV determination process according to Modified Example 1.

According to the storage destination PDEV determination process of Modified Example 1, during the process, multiple candidates of PDEVs being the storage destination are selected. Therefore, at first in S8131, the controller 11 prepares a data structure (such as a list or a table) for temporarily storing the candidate PDEVs to be set as the storage destination, and initializes the data structure (a state is realized where no data is stored in the data structure). In the following, the data structure prepared here is called a “candidate PDEV list”.

Next, the controller 11 selects one anchor chunk fingerprint not yet set as the processing target of S8132 and thereafter out of the generated one or multiple anchor chunk fingerprints (S8132), and searches whether the selected anchor chunk fingerprint exists in the index 300, that is, whether there is an entry having the same value stored in the anchor chunk fingerprint 301 of the index 300 as the selected anchor chunk fingerprint (S8133). In the following description, the entry searched here is called a “hit entry”. According to Modified Example 1, all the entries having the same value as the selected anchor chunk fingerprint stored therein are searched in the searching process of S8133. In other words, there may be multiple hit entries.

When a hit entry exists (S8134: Yes), the controller 11 stores the information of the PDEV specified by the anchor chunk information 1 (302) of the respective hit entries in the candidate PDEV list (S8135). As mentioned earlier, there may be multiple hit entries. Therefore, in S8135, when there are multiple hit entries, multiple PDEV information are stored in the candidate PDEV list.

If a hit entry does not exist (S8134: No), the controller 11 checks whether the determination of S8134 has been performed for all the anchor chunk fingerprints generated in S802. When there is an anchor chunk fingerprint where the determination of S8134 is not yet executed (S8136: No), the controller 11 repeats the processes from S8132. When the determination of S8134 has been performed for all anchor chunk fingerprints (S8136: Yes), the controller 11 determines whether the candidate PDEV list is empty or not (S8137). If the candidate PDEV list is empty (S8137: Yes), the controller 11 determines an invalid value as the storage destination PDEV (S8138), and ends the storage destination PDEV determination process.

If the candidate PDEV list is not empty (S8137: No), the controller 11 determines the PDEV 17 having the greatest free capacity out of the PDEVs 17 registered in the candidate PDEV list as the storage destination PDEV (S8139), and ends the storage destination PDEV determination process. The free capacity of the respective PDEVs 17 is calculated by counting the total number of physical stripe #s stored in the free stripe list 704 of the PDEV management information 700. By determining the storage destination PDEV in this manner, the amount of use of the respective PDEVs can be made even.

### Modified Example 2

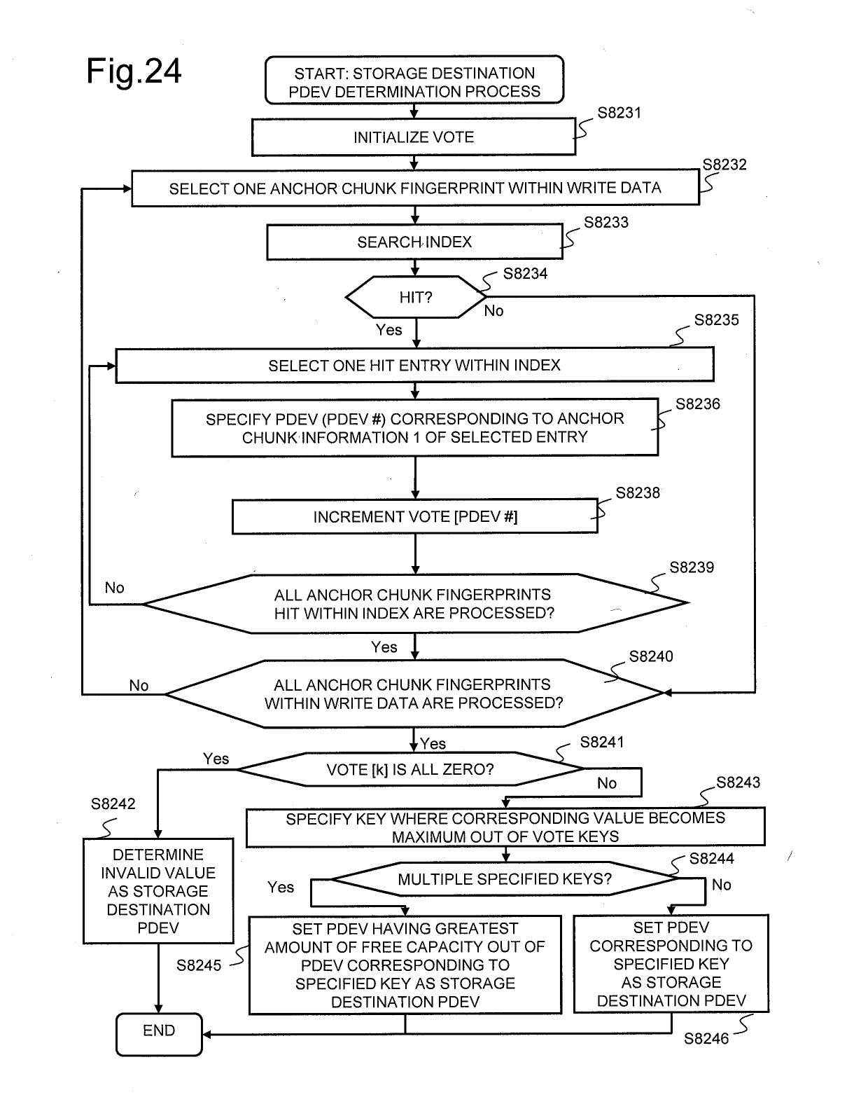

Now, the second modified example of the storage destination PDEV determination process will be described. FIG. 24 is a flowchart of the storage destination PDEV determination process according to Modified Example 2.

According to the storage destination PDEV determination process of Modified Example 2, whether all the anchor chunk prints generated in S802 exist in the index 300 or not is determined. Therefore, at first in S8231, the controller 11 prepares a data structure (one example of which is an array) for temporarily storing the candidate PDEV as the storage destination, and initializes the data structure. The data structure (array) prepared here is the array whose number of elements is equal to the total number of PDEVs 17 within the storage 10. The data structure prepared here is referred to as “Vote [k]” (0≦k≦total number of PDEVs 17 within storage 10). Further, the value (k) in the bracket is called “key”. In the initialization of the data structure performed in S8231, the values of Vote [0] through Vote [total number of PDEVs 17 within storage 10−1] are all set to 0.

Next, one of the anchor chunk fingerprints generated in S802 is selected (S8232), and a search is performed on whether the selected anchor chunk fingerprint exists in the index 300, that is, whether there is an entry storing the same value as the selected anchor chunk fingerprint in the anchor chunk fingerprint 301 of the index 300 or not (S8233). In the following description, the entry searched here is called a “hit entry”. In Modified Example 2, in the search processing of S8233, all the entries storing the same value as the selected anchor chunk fingerprint are searched. That is, multiple hit entries may exist.

When a hit entry exists (S8234: Yes), the controller 11 selects one hit entry (S8235). Then, the PDEV# specified by the anchor chunk information 1 (302) of the selected entry is selected (S8236). The following description describes as an example of a case where the selected PDEV# is n. In S8238, the controller 11 increments (adds 1 to) Vote [n].

When the processes of S8235 through S8238 have been executed for all the hit entries (S8239: Yes), the controller 11 executes the processes of S8240 and thereafter. If a hit entry where the processes of S8235 through S8238 are not yet executed exists (S8239: No), the controller 11 repeats the processes from S8235.

When the selected anchor chunk fingerprint does not exist in the index 300 (S8234: No), or if the processes of S8235 through S8258 are executed for all the hit entries (S8239: Yes), the controller 11 checks whether the processes of S8233 through S8239 have been performed for all anchor chunk fingerprints generated in S802 (S8240). If there is still an anchor chunk fingerprint where the processes of S8233 through S8239 have not been performed (S8240: No), the controller 11 repeats the processes from S8232. When the processes of S8233 through S8239 have been performed for all anchor chunk fingerprints (S8240: Yes), whether Vote [0] through Vote [total number of PDEVs 17 within storage 10−1] are 0 or not is determined (S8241).

When Vote [0] through Vote [total number of PDEVs 17 within storage 10−1] are all 0 (S8241: Yes), the storage destination PDEV is set to an invalid value (S8242), and the storage destination PDEV determination process is ended.

When any one of Vote [0] through Vote [total number of PDEVs 17 within storage 10−1] is not 0 (S8241: No), the key of the element storing the maximum value out of Vote [0] through Vote [total number of PDEVs 17 within storage 10−1] is specified (S8243). There may be multiple keys. Hereafter, we will describe a case where the key of the element storing the maximum value is k and j (0≦k, j<total number of PDEVs 17 within storage 10, and where k≠j), that is, when Vote [k] and Vote [j] are the maximum values within Vote [0] through Vote [total number of PDEVs 17 within storage 10−1].

In S8244, the controller 11 determines whether there are multiple keys specified in S8243 or not. In the following, we will first describe a case where there are multiple specified keys, wherein the keys are k and j (0≦k, j<total number of PDEVs 17 within storage 10, and where k≠j) (that is, when Vote [k] and Vote [j] are maximum values within Vote [0] through Vote [total number of PDEVs 17 within storage 10−1]).

When there are multiple keys specified in S8243 (S8244: Yes), for example, if the specified keys are k and j, the controller 11 selects PDEVs 17 where the PDEV # are k or j as candidate PDEVs. Then, out of the selected candidate PDEVs, the PDEV 17 having the greatest free capacity is determined as the storage destination PDEV (S8245), and the storage destination PDEV determination process is ended.

When there is only one key specified in S8243 (S8244: No), the PDEV corresponding to the specified key (for example, if the only specified key is k, the PDEV having PDEV # k will be the PDEV corresponding to the specified key) is determined as the storage destination PDEV (8246), and the storage destination PDEV determination process is ended.

In the storage destination PDEV determination process according to Modified Example 2, the search processing within the index 300 is performed for all anchor chunk fingerprints generated from the write data, and the PDEV storing the data corresponding to the anchor chunk fingerprint generated from the write data is specified for multiple times. Then, the PDEV determined the most times to store the data corresponding to the anchor chunk fingerprint generated from the write data is determined as the storage destination PDEV, so that the probability of deduplicating the write data can be increased compared to the storage destination PDEV determination process of Embodiment 1 or Modified Example 1. Further, if multiple PDEVs exist which are determined the most times to store the data corresponding to the anchor chunk fingerprint generated from the write data, the PDEV having the greatest free capacity out of the multiple PDEVs is set as the storage destination PDEV, so that similar to the Modified Example 1, the amount of use of the respective PDEVs can be made even.

### Modified Example 3

In Modified Example 3, the modified example of the similar data storage process described in Embodiment 1 will be described. According to the similar data storage process described in Embodiment 1, the write data has been controlled to be stored in the PDEV 17 having the physical stripe including the similar data (data having the same anchor chunk fingerprint) of the write data. As a modified example, when a physical stripe including the similar data of the write data (relevant write data) received from the host computer 20 exists, it is possible to read the relevant similar physical stripe and to store both the relevant write data and the data stored in the similar physical stripe to an arbitrary PDEV 17. The flow of the processes according to this case will be described.

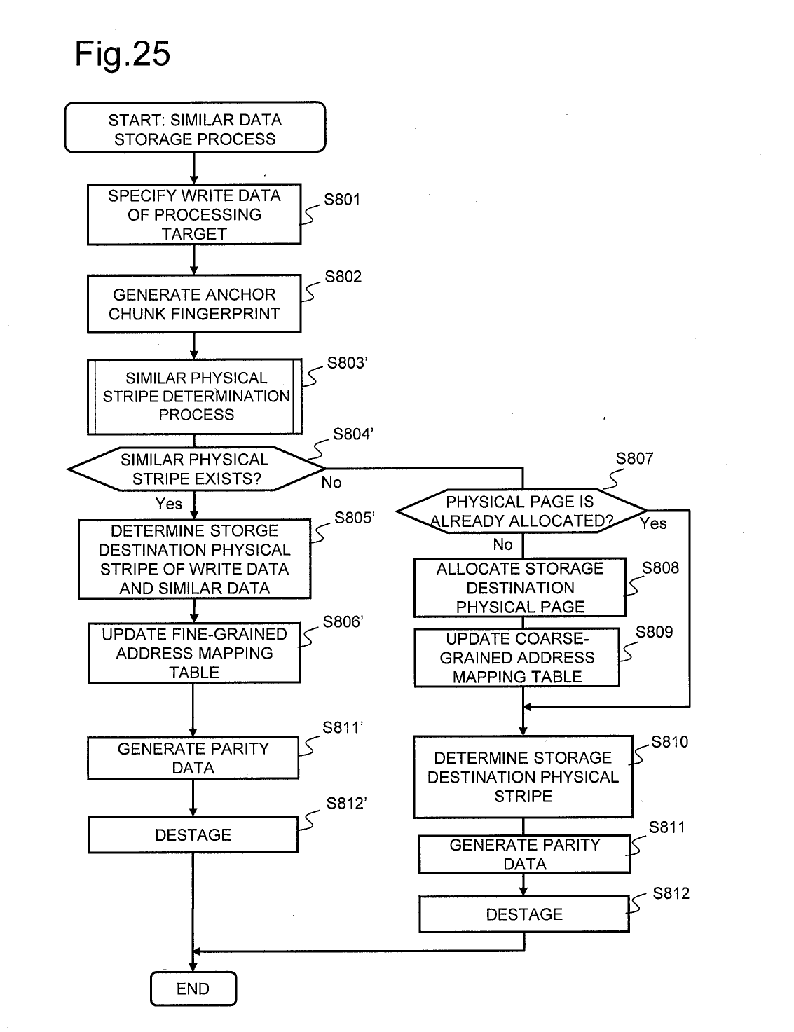

FIG. 25 is a flowchart of a similar data storage process according to Modified Example 3. This process has many points in common with the similar data storage process (FIG. 15) described in Embodiment 1, so in the following, the differences therefrom are mainly described. At first, S801 and S802 are the same as Embodiment 1.

In S803′, the controller 11 performs a similar physical stripe determination process. The details of this process will be described later. As a result of processing S803′, when a similar physical stripe is not found (S804′: No), the controller 11 performs the processes of S807 through S812. This process is the same as S807 through S812 described in Embodiment 1.

If a similar physical stripe is found (S804′: Yes), the controller 11 determines the storage destination physical stripe of the relevant write data and the storage destination physical stripe of the similar data, so as to store the relevant write data and the data stored in the similar physical stripe (hereinafter, this data is called “similar data”) to a common PDEV 17 (S805′). An unused physical stripe existing in a single arbitrary PDEV 17 within the pool 45 can be selected as the storage destination physical stripe. Therefore, it can be selected from a RAID group other than the one where the similar physical stripe exists.

In S806′, the controller 11 associates the determined information of the physical stripe (RAID group # and physical stripe #) with the virtual VOL # and the virtual page # of the write destination of the relevant write data, and registers the same in the fine-grained address mapping table 600. Further, based on the virtual VOL # and VBA corresponding to the similar physical stripe (information determined by the similar physical stripe determination process of S803′ described later), the virtual stripe # corresponding to the similar physical stripe is specified. Then, the RAID group # to which the unused physical stripe for storing the similar data belongs and the physical stripe # allocated in S805′ are stored in the RAID group #603 and the physical stripe #604 of the row corresponding to the virtual VOL # (601) and the virtual stripe # (602) specified here.

In S811′, the controller 11 generates a parity data corresponding to the similar data, in addition to the parity data corresponding to the relevant write data. When generating a parity data corresponding to the similar data, the similar data is read from the similar physical stripe. The reason for this is that in addition to the similar data being required for generating parity data, the similar data is required to be moved to the unused physical stripe allocated in S805′. Lastly, in addition to the relevant write data and the parity thereof, the similar data and the parity corresponding thereto are destaged (S812′), and the process is ended.

Next, we will describe the similar physical stripe determination process of S803′. According to this process, a similar process as the storage destination PDEV determination process described in Embodiment 1 (or Modified Examples 1 and 2) is performed. Therefore, with reference to FIG. 16, the flow of the similar physical stripe determination process will be described. In the storage destination PDEV determination process, the information of the storage destination PDEV has been returned to the call source similar data storage process, but in the similar physical stripe determination process, in addition to the information of the storage destination PDEV, the PDEV # and the physical stripe # of the PDEV storing the similar physical stripe, the virtual VOL # corresponding to the similar physical stripe, and the VBA are returned.

The processes of S8031 through S8033 are the same as FIG. 16. In the similar physical stripe determination process, in S8034, the PDEV and the PBA in which the similar physical stripe exists are specified by referring to the anchor chunk information 1 (302) of the target entry. Then, the PBA is converted to the physical stripe #. Further, by referring to the anchor chunk information 2 (303), the VVOL # and VBA of the virtual volume to which the similar physical stripe is mapped are specified. Then, these specified information are returned to the call source, and the process is ended.

Further, in S8033, when the anchor chunk fingerprint of the relevant write data does not exist in the index 300, an invalid value is returned to the call source (S8036), and the process is ended.

The above has described the flowcharts of the similar data storage process and the similar physical stripe determination process according to Modified Example 3. The other processes, such as the overall process described with reference to FIG. 14 in Embodiment 1, are the same as the one described in Embodiment 1. In the above description, the flow of the similar physical stripe determination process has been described using the storage destination PDEV determination process (FIG. 16) according to Embodiment 1, but the similar physical stripe determination process is not restricted to this example. For example, by performing a similar process as the storage destination PDEV determination process (FIG. 23 or FIG. 24) according to Modified Examples 1 or 2, the PDEV and the physical stripe # in which the similar physical stripe exists and the VVOL # and VBA of the virtual volume to which the similar physical stripe is mapped can be determined, and returned to the call source.

According to Modified Example 3, the flexibility of write destination of the write data and similar data can be increased, so that the amount of use of the respective PDEVs can be made more uniform.

The present invention is not restricted to the various embodiments and modified examples described above, and various modifications are possible. For example, RAID6 can be adopted instead of RAID5 as the RAID level of the RAID group.

### REFERENCE SIGNS LIST

1 Computer system
10 Storage
20 Host
30 Management terminal
11 Controller
17 PDEV

1. A storage subsystem comprising multiple storage devices, and a controller for executing an I/O processing to the storage device by receiving an I/O request from a host computer, the controller having an index for managing a representative value of the respective data stored in the storage devices; wherein
when the controller receives a write data from the host computer, the controller:
calculates a representative value of the write data using the write data; and
when a same representative value as the representative value of the write data is stored in the index,
determines to store the write data and the data corresponding to the same representative value in the same said storage device.

2. The storage subsystem according to claim 1, wherein
the controller determines the storage device for storing the write data, and then transmits the write data to the storage device; and
out of the write data received from the controller, the storage device will not store the same data as the data stored in the storage device in a storage media of the storage device.

3. The storage subsystem according to claim 2, wherein
the controller manages the multiple storage devices as one or more RAID groups, and also manages storage areas of the multiple storage devices in stripe units having given sizes;
after determining the storage device for storing the write data and a stripe set as a storage destination within the storage device;
the controller generates a parity to be stored in a parity stripe within a same stripe array as the stripe set as the storage destination of the write data; and
stores the generated parity to the storage device to which the parity stripe belongs.

4. The storage subsystem according to claim 3, wherein
when the same representative value as the representative value of the write data is stored in the index, the controller reads a data corresponding to the same representative value from the storage device; and
determines to store the write data and the data read from the storage device to the same storage device.

5. The storage subsystem according to claim 3, wherein
when the same representative value as the representative value of the write data is stored in the index, the controller determines one stripe of the storage device storing the data corresponding to the same representative value as a storage destination stripe of the write data.

6. The storage subsystem according to claim 1, wherein
the controller divides the write data into multiple chunks;
calculates a hash value for each of the multiple chunks; and
determines one or more of the hash values selected based on a given rule from the calculated multiple hash values as the representative value of the write data.

7. The storage subsystem according to claim 1, wherein
when a plurality of the representative values of the write data are selected,
the controller determines whether the same representative value as the representative value is stored in the index for each of the plurality of the representative values; and
a stripe within the storage device having a greatest free capacity out of the one or more storage devices storing the data corresponding to the same representative value is determined as a storage destination stripe of the write data.

8. The storage subsystem according to claim 6, wherein
when a plurality of the representative values of the write data are selected;
the controller executes a process for specifying the storage device storing a data corresponding to the same representative value as the representative value for each of the plurality of the representative values; and
as a result of the process, stores the write data to the storage device determined the most number of times to be storing data corresponding to the same representative value as said representative value.

9. The storage subsystem according to claim 8, wherein
as a result of the process, the write data is stored in the storage device having a greatest free capacity out of the multiple storage devices determined the most number of times to be storing data corresponding to the same representative value as said representative value.

10. The storage subsystem according to claim 3, wherein
the storage subsystem provides to the host computer a virtual volume composed of multiple virtual stripes which are data areas having a same size as the stripes;
the controller has a mapping table for managing mapping of the virtual stripes and the stripes;
the controller receives information for specifying the virtual stripe as a write destination of the write data together with the write data from the host computer; and
after determining a storage destination stripe of the write data, the controller stores a mapping information of the virtual stripe set as a write destination of the write data and storage destination stripe of the write data in the mapping table.

11. The storage subsystem according to claim 10, wherein
the storage device is configured to return a capacity of the storage device to the controller after storing the data; and
the controller changes an amount of the stripes that can be mapped to the virtual volume based on the capacity of the storage device received from the storage device.

12. The storage subsystem according to claim 11, wherein
the storage device calculates a deduplication rate by dividing a data quantity prior to deduplication of data stored in the storage device by a data quantity after deduplication; and
returns a value calculated by multiplying the deduplication rate to a total quantity of storage media within the storage device as a capacity of the storage device to the controller.

13. The storage subsystem according to claim 12, wherein
the controller calculates a capacity of the RAID group based on a minimum value of capacity of each of the storage devices constituting the RAID group; and
when a difference between a capacity of the calculated RAID group and a capacity of the RAID group prior to calculation has been increased by a given value or greater, the amount of stripes capable of being mapped to the virtual volume is increased by an amount corresponding to the difference.

14. In a storage subsystem comprising multiple storage devices and a controller having an index for managing representative values of respective data stored in the storage device, a method for controlling the storage subsystem by the controller comprising:
receiving a write data from a host computer;
calculating a representative value of the write data using the write data; and
when a same representative value as the representative value of the write data is stored in the index, determining to store the write data and the data corresponding to the same representative value in the same storage device.

15. The method for controlling the storage subsystem according to claim 14 further comprising:
transmitting the write data to the storage device after determining the storage device for storing the write data; and
out of the write data received from the controller, the storage device storing only data that differs from the data stored in the storage device to a storage media within the storage device.
